(19) United States
(12) Patent Application Publication
(10) Pub. No.: US 2026/0357076 A1
(43) Pub. Date: Nov. 12, 2026

(54) METHODS AND ADDITIVES TO IMPROVE PERFORMANCE OF CARBON PARTICLES IN ELASTOMER COMPOSITES

(71) Applicant: MONOLITH MATERIALS, INC., Lincoln, NE (US)

(72) Inventors: Ned J. Hardman, Lincoln, NE (US); Mason Mccormick, Lincoln, NE (US); Lucas Wilke, Lincoln, NE (US); Connor Adams, Lincoln, NE (US); Matthew Jamison, Lincoln, NE (US); Thomas Maier, Lincoln, NE (US)

(73) Assignee: MONOLITH MATERIALS, INC., Lincoln, NE (US)

(21) Appl. No.: 19/123,032

(22) PCT Filed: Oct. 20, 2023
(86) PCT No.: PCT/US2023/077479

§ 371 Date: Apr. 21, 2025

Related U.S. Application Data
(60) Provisional application No. 63/418,358, filed on Oct. 21, 2022.

(51) Int. Cl. C09C 1/44; C01B 32/05; C08K 9/02; C08K 9/04

(52) U.S. Cl. CPC C09C 1/44; C01B 32/05; C08K 9/02; C08K 9/04; C01P 2004/61; C01P 2006/12; C08K 2201/003; C08K 2201/006

(57) ABSTRACT

In an aspect, the present disclosure provides methods and additives to improve performance of carbon particles in elastomer composites. The present disclosure provides systems and methods for generating carbon particles decorated with one or more hydrates, hydrated salts, carboxylate salts, carboxylates, or carboxylic acids. The present disclosure provides systems and methods for drying the treated and pelletized carbon pellets decorated with one or more hydrates, hydrated salts, carboxy late salts, carboxylates, or carboxylic acids. The carbon particles decorated with one or more hydrates, hydrated salts, carboxylate salts, carboxylates, or carboxylic acids can be utilized in elastomer reinforcement processes.

### CROSS-REFERENCE

This application is related to and claims the benefit of priority under 35 U.S.C. § 119(e) from U.S. Provisional Patent Application No. 63/418,358, filed Oct. 21, 2022, the disclosure of which is expressly incorporated herein by reference in its entirety.

### BACKGROUND

Carbonaceous materials, hydrogen, and other products are produced by various chemical processes. Performance, energy supply and environmental performance associated with such chemical processes have evolved over time. For example, energy sources have evolved in chemical processes such as carbon black production from simple flame, to oil furnace, to plasma, to name a few. As in all manufacturing, there is a constant search for more efficient and effective production methods, for new and improved products, and for improved performance.

### SUMMARY

Recognized herein is a need for the methods and additives of the present disclosure to enhance the performance of plasma produced carbon particles in the reinforcement of rubber and other elastomeric compounds. As a large proportion of produced carbon particles (e.g., greater than about 85% of the world's produced carbon black) is used for the reinforcement of elastomers (e.g., rubber articles including tires, EPDM based weather stripping, and the like), carbon particle performance in elastomeric reinforcement can be an important if not critical property. Plasma produced carbon particles result in certain environmental benefits including substantially lower CO₂, SOₓ, and NOₓ emissions, as well as co-production of hydrogen, but may demonstrate decreased elastomeric reinforcement ability versus furnace produced carbon blacks. The methods and additives of the present disclosure can improve the elastomeric reinforcement properties of both plasma produced and furnace produced carbon particles.

In an aspect, the present disclosure provides a method that may comprise providing a carbon particle and adding, to the carbon particle, an additive mixture comprising one or more of a hydrate, a hydrated salt, a carboxylate salt, a carboxylate, or a carboxylic acid, thereby forming a treated carbon particle.

In some embodiments, the carbon particle may be carbon black. In some embodiments, the method may comprise first generating the carbon particle in a plasma process or a furnace process. In some embodiments, the method may occur in an environment containing less than about 5% oxygen or in an oxygen-fee environment. In some embodiments, the treated carbon particle may comprise at most about 1.5% by mass of the hydrate, hydrated salt, carboxylate salt, carboxylate, or carboxylic acid.

In some embodiments, the method may further comprise pelletizing the treated carbon particle to generate a carbon pellet. In some embodiments, the method may further comprise drying the carbon pellet such that the one or more hydrate, hydrated salt, carboxylate salt, carboxylate, or carboxylic acid decorates the surface of the carbon pellet. In some embodiments, the drying may be to a moisture content in a range of about 0.2% to about 5%. In some embodiments, the method may further comprise using the carbon pellet in an elastomer reinforcement process.

In another aspect, the present disclosure provides a carbon particle comprising a surface decorated with one or more of a hydrate, a hydrated salt, a carboxylate salt, a carboxylate, or a carboxylic acid (“additive” in the Summary paragraphs that follow). In some embodiments, the additive may be present at a ratio of less than about 1.5% by mass, may increase a hydrophilic spreading pressure of the carbon particle of a carbon pellet when compared to the carbon particle absent the additive, or may be configured to release water from the additive. In some embodiments, the carbon particle may comprise at least about 90% carbon by mass, or have a volume equivalent sphere diameter of at most about 2 micrometers. In some embodiments, the carbon particle may have a ratio of carbon-12 to carbon-14 of at least about 1:1×10⁻¹³. In some embodiments, the carbon particle may be carbon black.

In some embodiments, the present disclosure provides a carbon pellet comprising a plurality of carbon particles comprising the carbon particle. In some embodiments, the plurality of carbon particles may comprise at least about 90% particles with a volume equivalent sphere diameter of at most about 2 micrometers. In some embodiments, the carbon pellet may comprise a binder. In some embodiments, the carbon pellet may have a moisture content in a range of about 0.2% to about 5%, or a surface area of at least about 5 square meters per gram (m²/g).

In some embodiments, the present disclosure provides a composite comprising an elastomer and the carbon particle. In some embodiments, the composite may have a modulus at 300% elongation (M300) of at least about 10% more than a composite comprising the elastomer and a similar but different carbon particle that does not comprise the surface decorated with the additive. In some embodiments, the composite may have a ratio of M300 to a modulus at 100% elongation (M300/M100) of at least about 5% more than a composite comprising the elastomer and a similar but different carbon particle that does not comprise the surface decorated additive.

In some embodiments, the elastomer of the composite may be selected from a group consisting of natural rubber, polybutadiene, polyisobutylene, polyisoprene, nitrile rubber, butyl rubber, halobutyl, ethylene propylene rubber, ethylene propylene diene rubber, silicone rubber, and a fluoroelastomer.

In another aspect, the present disclosure provides a carbon particle comprising the carbon particle and one or more of a hydrate, a hydrated salt, a carboxylate salt, a carboxylate, or a carboxylic acid decorating a surface of the carbon particle, wherein an elastomer reinforcement performance value of the carbon particle when heated at about 200° C. for about 12 hours returns to a level substantially the same as a carbon particle without a decorated surface, and wherein the carbon particle with the decorated surface, when heated to a temperature of at most about 110° C., provides an improved M300 of at least about 10% as compared to the carbon particle without the decorated surface heated at about 200° C. for about 12 hours. In some embodiments, the drying of the carbon particle may be performed in a fluidized bed dryer at a bed temperature that does not exceed 120° C.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present disclosure will be obtained by reference to the following detailed description that sets forth illustrative embodiments, in which the principles of the present disclosure are utilized, and the accompanying drawings (also “Figure” and “FIG.” herein), of which:

FIG. 1 shows an example method according to one or more embodiments of the present disclosure;

FIG. 2 shows a schematic representation of an example system that can be used to provide a carbon particle (see FIG. 1 item 110) according to one or more embodiments of the present disclosure;

FIG. 3 shows an example of a plasma reactor that can be used to provide a carbon particle (see FIG. 1 item 110) according to one or more embodiments of the present disclosure;

FIG. 4 is a table showing various measured physical properties of carbon black samples generated by furnace process (furnace blacks), treated with baseline (“A”) surface modification, and dried under various conditions, according to one or more embodiments of the present disclosure;

FIG. 5 is a table showing various measured performance properties of elastomer composites made using the furnace blacks of FIG. 4, according to one or more embodiments of the present disclosure;

FIG. 6 is a table showing various measured physical properties of carbon black samples generated by plasma reactor (Plasma Blacks), treated with baseline (“A”) or other surface modification (“G” for sample 6G-M762), and dried under various conditions, according to one or more embodiments of the present disclosure;

FIG. 7 is a table showing various measured physical properties of carbon black samples generated by plasma reactor (Plasma Blacks), treated with baseline (“A”) or other surface modification (“F” for samples 4F1-M550 and 4F2-M550 and “H” for sample 4H-M550), and dried under various conditions, according to one or more embodiments of the present disclosure;

FIG. 8 is a table showing various measured physical properties of carbon black samples generated by plasma reactor (Plasma Blacks), treated with baseline (“A”) or other surface modification (“G” for samples 8G1-M762 and 8G2-M762), and dried under various conditions, according to one or more embodiments of the present disclosure;

FIG. 9 is a table showing various measured performance properties of elastomer composites made using the Plasma Blacks of FIG. 6, according to one or more embodiments of the present disclosure;

FIG. 10 is a table showing various measured performance properties of elastomer composites made using the Plasma Blacks of FIG. 7, according to one or more embodiments of the present disclosure;

FIG. 11 is a table showing various measured performance properties of elastomer composites made using the Plasma Blacks of FIG. 8, according to one or more embodiments of the present disclosure; and

FIG. 12 shows an example computer system that is programmed or otherwise configured to implement any of the methods provided herein.

### DETAILED DESCRIPTION

While various embodiments of the present disclosure are shown and described herein, those skilled in the art will understand that such embodiments are provided by way of example only. Numerous variations, changes, and substitutions may occur to those skilled in the art without departing from the present disclosure. It should be understood that various alternatives to the embodiments described herein may be employed.

Whenever the term “at least,” “greater than,” or “greater than or equal to” precedes the first numerical value in a series of two or more numerical values, the term “at least,” “greater than,” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Certain embodiments herein contemplate numerical ranges. When ranges are present, the ranges include the range endpoints. Additionally, every sub range and value within the range is present as if explicitly written out. The term “about” or “approximately” may mean within an acceptable error range for the particular value, which will depend in part on how the value is measured or determined, e.g., the limitations of the measurement system. For example, “about” may mean within one or more than one standard deviation, per the practice in the art. Alternatively, “about” may mean a range of up to 20%, up to 10%, up to 5%, or up to 1% variation with respect to a given value. Where particular values are set forth herein, unless otherwise stated, it may be assumed that the term “about” means within an acceptable error range for the particular value.

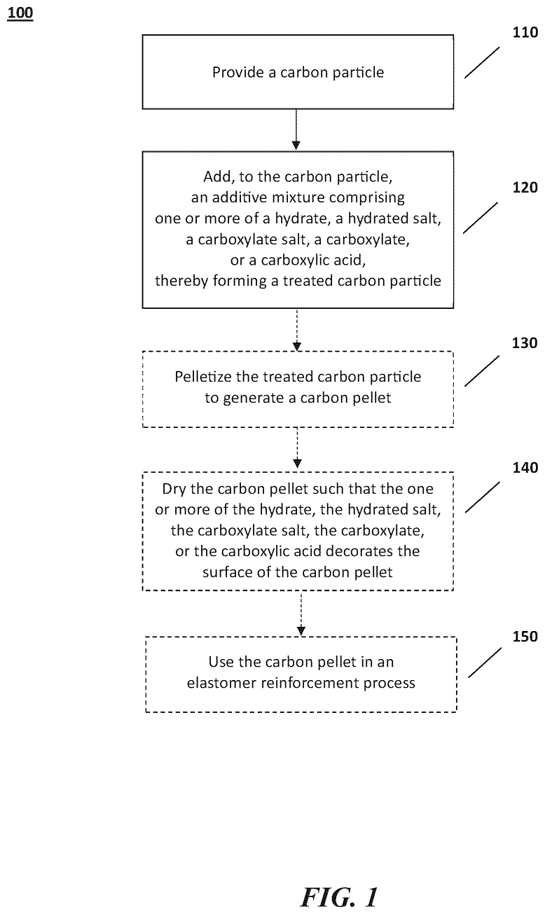

FIG. 1 shows an example method 100 according to one or more embodiments of the present disclosure. In an operation 110, method 100 may comprise providing a carbon particle. As used herein, the term “carbon particle” may refer to a particle comprising carbon. Examples of carbon particles include, but are not limited to, carbon black, coke, needle coke, graphite, large ring polycyclic aromatic hydrocarbons, activated carbon, or the like, or any combination thereof. Carbon particles may be classified into grades. The carbon particles of the present disclosure may be of any grade or no grade at all.

In some cases, prior to operation 110, the carbon particle (e.g., carbon black) may be generated in a plasma process. For example, the carbon particle may be generated using a plasma-based degradation of a hydrocarbon precursor. Non-limiting examples of plasma process generation of carbon particles can be found in at least, for example, Int. Pat. Pub.

Nos. WO 2017/190015, WO 2018/195460, and WO 2023/059520, each of which is incorporated herein by reference in its entirety. In some cases, prior to operation 110, the carbon particle (e.g., carbon black) may be generated in a furnace process. The furnace process may utilize incomplete combustion of a hydrocarbon precursor to generate the carbon particle.

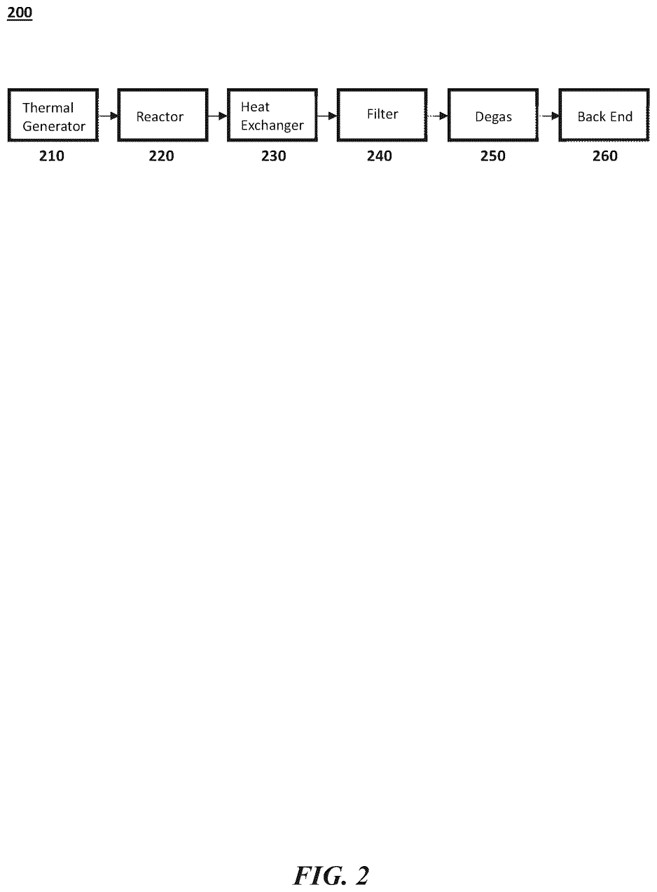

FIG. 2 shows a schematic representation of an example system 200 that can be used to provide a carbon particle (see FIG. 1 item 110) according to one or more embodiments of the present disclosure. The system 200 may include a thermal generator (e.g., a plasma generator) 210. The thermal generator 210 may heat at least a subset of one or more gases (e.g., a feedstock) at suitable reaction conditions in a reactor (or furnace) 220 to effect removal of a chemical (e.g., hydrogen) from the feedstock. The reactor 220 may contain the thermal generator (e.g., a plasma generator) 210. Heating (e.g., electrical heating, such as, for example, plasma heating) and reaction may be implemented in one chamber (e.g., “single chamber,” “single stage reactor,” or “single stage process”) or multiple chambers (e.g., “dual chamber,” “dual stage reactor,” “dual stage process,” “multiple chamber,” “multiple stage reactor,” “multiple stage process,” “multi-chamber,” “multi-stage reactor,” “multi-stage process,” or the like). The reactor 220 may comprise one or more constant diameter regions/sections, one or more converging regions/sections, one or more diverging regions/sections, one or more additional components, or any combination thereof. Such regions/sections, or additional components, may be combined in various ways to implement the heating and reaction in accordance with the present disclosure. For example, the reactor may have a substantially constant diameter (e.g., at least about 70%, 80%, 90%, 95% or 99% of the reactor's length may be of a constant diameter). Alternatively, or in addition, the reactor may have multiple sections, such as a first section and a second section, separated by a narrowing or a throat region (also referred to herein as a throat section or a throat). The first section may be a plasma generating section and the second section may be a carbon particle generating section. At least a subset of the one or more gases (e.g., a feedstock) may be added to the thermal generator 210.

Reaction products (e.g., solid carbonaceous material and gaseous reaction products) may be cooled after manufacture. A quench (e.g., comprising a process gas) may be used to cool the reaction products. For example, a quench comprising a majority of hydrogen gas may be used. The quench may be added (e.g., injected) in the reactor 220. A heat exchanger 230 (e.g., connected to the reactor 220) may cool an effluent stream comprising the reaction products. In the heat exchanger, gaseous reaction products may be exposed to a large surface area and thus allowed to cool while solid carbonaceous material may be simultaneously transported through the process. The solid carbonaceous material may pass through a filter (e.g., a main filter) 240 (e.g., connected to the heat exchanger 230). The filter may allow, for example, more than 50% of the gaseous reaction products to pass through, capturing substantially all of the solid carbonaceous material on the filter. For example, at least about 98% by mass of the solid carbonaceous material may be captured on the filter.

The gaseous reaction products may be provided or coupled to one or more uses, recycled back into the reactor (e.g., as a process gas), or any combination thereof. The solid carbonaceous material with residual gaseous reaction products may pass through a degasser (e.g., degas chamber or degas apparatus) 250 (e.g., connected to the filter 240), where the amount of combustible gas may be reduced (e.g., to less than about 10% by volume).

The solid carbonaceous material may then pass through back-end equipment 260. The back-end equipment 260 may include, for example, one or more of a pelletizer (e.g., connected to the degas apparatus 250), a binder mixing tank (e.g., connected to the pelletizer), a dryer (e.g., connected to the pelletizer), or a bagger, as non-limiting example(s) of components or unit operations. For example, the solid carbonaceous material (e.g., carbon black) may be pelletized in the pelletizer and dried in the dryer (e.g., mixed with water with a binder and then formed into pellets, followed by removal of the majority of the water in a dryer). The solid carbonaceous material may also pass through classifier(s), hammer mill(s), or other size reduction equipment (e.g., so as to reduce the proportion of grit in the product). As non-limiting examples of other components or unit operations, one or more of a conveying process or conveying unit, purge filter unit (e.g., which may filter solid carbonaceous material out of steam vented from the dryer), dust filter unit (e.g., which may collect dust from other equipment), other process filter, other hydrogen/tail gas removal unit, cyclone, other bulk separation (e.g., solid/gas separation) unit, off quality product blending unit, etc. (e.g., other components or unit operations described elsewhere herein) may be added or substituted in the system 200.

Components or unit operations may be added or removed as appropriate. For example, the system 200 may include at least one or more heat exchangers 230, one or more filters 240, and back-end equipment 260 comprising solids handling equipment. The solids handling equipment may include, for example, a cooled solid carbon collection screw conveyor, an air locking and purge system, a pneumatic conveying system, a mechanical conveying system (e.g., a conveyor belt auger or elevator), a classifying mill, and/or a product storage vessel. The carbon particles may be collected at a single location (e.g., all of the carbon particles may be collected at one location) or at multiple locations.

The feedstock (e.g., a hydrocarbon feedstock comprising one or more hydrocarbons, hydrocarbon derivatives, or combination thereof) may begin to crack and decompose before being converted into solid carbonaceous material. Heat may further be provided through latent radiant heat from the wall of the reactor 220. This may occur through heating of the walls (or portions thereof) via externally provided energy or through heating of the walls (or portions thereof) from the heated gases in the reactor 220. For example, hydrogen and carbonaceous material (e.g., carbon particles) may be produced in a process comprising adding a hydrocarbon feedstock (e.g., natural gas or renewable natural gas) to a plasma reactor 220 at or above atmospheric pressures. The hydrocarbon feedstock may be added through direct injection (e.g., direct injection of the feedstock) into the plasma generated by the thermal generator (e.g., plasma generator) 210. The energy from the thermal generator 210 may remove hydrogen from the hydrocarbon feedstock. The process may additionally include the use of one or more heat exchangers 230, filters 240, degas chambers 250, and/or solids handling equipment and other back-end equipment 260 as described above.

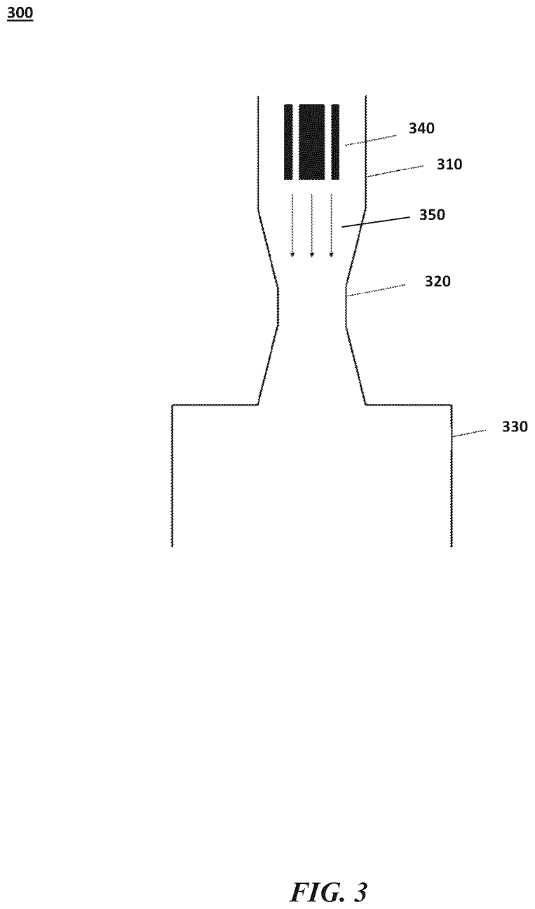

FIG. 3 shows an example of a plasma reactor 300 (see FIG. 2 item 220) that can be used to provide a carbon particle (see FIG. 1 item 110), according to one or more embodiments of the present disclosure. The plasma reactor 300 may be configured to execute the methods as described elsewhere herein. For example, the plasma reactor 300 may be configured to generate carbon particles as described elsewhere herein. The plasma reactor 300 may comprise an upstream section (e.g., torch region) 310, a throat section 320, and/or a downstream section (e.g., reactor region) 330. The upstream section 310 may comprise one or more plasma torches 340. The one or more plasma torches 340 may comprise at least about 1, 2, 3, 4, 5, 6, 7, 8, 9, 10, or more plasma torches. The one or more plasma torches 340 may be configured to provide a plasma (not shown) to the upstream section (e.g., torch region) 310. For example, the one or more plasma torches 340 may be configured to transform a gas (e.g., a transfer gas) into a plasma with aid of electrical energy. The plasma may be configured for use as a reactant in a carbon particle generating method. For example, the plasma may be used to provide heat to a carbon particle generating method. The plasma torch 340 may comprise an electrically conductive material. Examples of electrically conductive materials include, but are not limited to, carbon (e.g., graphite, glassy carbon, etc.), metals (e.g., iron, tungsten, gold, etc.), alloys (e.g., steel, etc.), polymers (e.g., conductive polymers), or the like, or any combination thereof. The plasma torch 340 may comprise a plurality of segments. For example, the plasma torch 340 may comprise a plurality of electrode portions (e.g., an anode, a cathode, a ground, or a combination thereof).

A gas (e.g., a transfer gas) may flow through the plasma reactor 300 in a bulk flow direction 350. For example, the direction of gas flow 350 can be from the upstream section (e.g., torch region) 310 through the throat section 320 into the downstream section (e.g., reactor region) 330. A transfer gas may be introduced to the plasma reactor 300 upstream of the upstream section (e.g., torch region) 310. For example, the transfer gas may be introduced via a pipe disposed upstream of the plasma torch 340. A transfer gas may be introduced to the plasma reactor 300 upstream of the throat section 320, in the throat section 320, downstream of the throat section 320, in the upstream section (e.g., reactor region) 310, or any combination thereof. Introducing transfer gas downstream of the plasma torch 340 may impact the temperature, flow rate, reaction rate, concentration, dilution, etc. of the plasma reactor 300.

The plasma reactor 300 may comprise one or more material injectors (not shown) that may be used to inject a feedstock (e.g., hydrocarbon feedstock) or other material. The injectors may be located upstream of the upstream section (e.g., torch region) 310, in the upstream section (e.g., torch region) 310, in the throat section 320, in the downstream section (e.g., reactor region) 330, or any combination thereof. Each section of the plasma reactor 300 may comprise one or more injectors. The one or more injectors may be distributed radially around or within the plasma reactor 300 or in any other configuration. The one or more injectors in a set or plurality of injectors may be configured to inject a same type of material. For example, each injector in a set of plurality of injectors may be configured to inject a hydrocarbon feedstock. For example, each injector in a set of plurality of injectors may be configured to inject a majority of a hydrocarbon feedstock downstream of an obstacle modulating a reacting flow, as described in contemporaneously filed Int. Pat. App. No. PCT/US2023/077402, entitled “Systems and Methods for Modulating Reacting Flows,” which is incorporated herein by reference in its entirety.

A hydrocarbon feedstock may be or comprise any chemical with formula CₙHₓ or CₙHₓO_{y}, where n is an integer; x is between (i) 1 and 2 n+2 or (ii) less than 1 for fuels such as coal, coal tar, pyrolysis fuel oils, and the like; and y is between 0 and n. The hydrocarbon feedstock may include simple or linear hydrocarbons (e.g., methane, ethane, propane, butane, etc.), cyclic hydrocarbons (e.g., cyclopropane, cyclobutene, cyclopentane, cyclohexane, etc.), aromatic feedstocks (e.g., benzene, toluene, ethylbenzene, xylene, naphthalene, methyl naphthalene, pyrolysis fuel oil, coal tar, coal, heavy oil, oil, bio-oil, bio-diesel, other biologically derived hydrocarbons, etc.), unsaturated hydrocarbons (e.g., ethylene, propylene, acetylene, butadiene, styrene, etc.), oxygenated hydrocarbons (e.g., alcohols, ethanol, methanol, propanol, phenol, ketones, ethers, esters, carboxylic acids, anhydrides, etc.), or the like, or any combination thereof. These examples are provided as non-limiting examples of acceptable hydrocarbon feedstocks which may be further combined or mixed with other components for manufacture. A hydrocarbon feedstock may refer to a feedstock in which the majority of the feedstock (e.g., more than about 50% by mass) is hydrocarbon (e.g., hydrocarbon and/or hydrocarbon derivative) in nature. The hydrocarbon feedstock may comprise any one or more, or a plurality, of hydrocarbon and/or hydrocarbon derivative and/or hydrocarbon mixture (“Hydrocarbon”) materials. The hydrocarbon feedstock may comprise at least about 1, 2, 3, 4, 5, 6, 7, 8, 9, 10, or more different Hydrocarbon materials as described above. The hydrocarbon feedstock may comprise at most about 10, 9, 8, 7, 6, 5, 4, 3, 2, or 1 different Hydrocarbon materials as described above. The hydrocarbon feedstock may comprise at least about 5, 10, 15, 20, 25, 30, 35, 40, 45, 50, 55, 60, 65, 70, 75, 80, 85, 90, 95, 96, 97, 98, 99, 99.9, or more percent by mass of a single Hydrocarbon material as described above. The hydrocarbon feedstock may comprise at most about 99.9, 98, 97, 96, 95, 90, 85, 80, 75, 70, 65, 60, 55, 50, 45, 40, 35, 30, 25, 20, 15, 10, 5, or less percent by mass of a single Hydrocarbon material as described above. The hydrocarbon feedstock may comprise or be natural gas or renewable natural gas.

The one or more injectors may be configured to inject a plurality of types of feedstock or other material. For example, the injectors may be configured to inject both natural gas and an aromatic compound at the same time. In some cases, separate gas and liquid injectors may be used to inject the feedstock. In some cases, the gaseous feedstock (e.g., natural gas or renewable natural gas) can be used to atomize a liquid or semi-liquid feedstock (e.g., feedstock that is heated to achieve a predetermined flow rate through the system).

The downstream section 330 (also referred to as “reactor region” herein) may be configured to have a residence time. For non-limiting example, a residence time may be the time that the gaseous mixture spends at a temperature of greater than about 1,100 degrees Celsius (° C.). The reactor region 330 may be configured to have a residence time of at least about 0.01, 0.05, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 5, 6, or more seconds. The reactor region 330 may be configured to have a residence time of at most about 6, 5, 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, 0.1, 0.05, 0.01, or fewer seconds. The reactor region 330 may be configured to have a residence time in a range as defined by any two of the preceding values. For example, the reactor region may be configured to have a residence time in a range from about 0.2 seconds to about 3 seconds.

The plasma reactor 300 may comprise no or substantially no restriction or obstacle between upstream section 310 and downstream section 330 in or near the throat section 320. Such a reactor may generate larger carbon particles (e.g., not nanoparticles and/or not carbon black) or solids comprising a large primary particle size. This can result in equipment fouling. Fouling material may be an unwanted buildup of solids on containment walls (e.g., internal walls of the reactor 300). Fouling may generate run-away propagation and premature shutdown of equipment. Buildup of solids on the containment walls (e.g., reactor fouling) may be reduced through control of time of flight of reacting flows using the systems and methods (hereinafter collectively referred to as the “Flow Straightener”) of the aforementioned Int. Pat. App. No. PCT/US2023/077402, incorporated by reference above.

The methods and additives of the present disclosure can provide for improvements to the elastomer reinforcement properties of carbon particles produced in a system or by a method comprising a Flow Straightener.

Returning to FIG. 1, in some cases, prior to operation 110, the carbon particle can be degassed (see FIG. 2 item 250). The degassing may comprise an at least partial removal of one or more gases from the carbon particle. The one or more gases may be associated with the carbon particle from the synthesis of the carbon particle (e.g., gases from the synthesis atmosphere, byproduct gases from the synthesis, etc.), from the processing of the carbon particle (e.g., carrier gas added during the movement of the carbon particle through the generation system, etc.), a quench gas, an additive gas, or the like, or any combination thereof. Examples of carrier gases include, but are not limited to, carbon monoxide, hydrogen, argon, krypton, other noble gases, and nitrogen.

The degassing may remove reactive gases, non-reactive gases, or both reactive and non-reactive gases from the carbon particle. In some cases, the degassing may remove reactive gases from the carbon particle. For example, for a carbon particle generated with hydrogen or in a hydrogen environment, the degassing may remove at least a part of the hydrogen from pores of the carbon particle, thereby improving the safety of handling the carbon particle. The degassing to remove hydrogen from the pores of a carbon particle may be considered complete when the hydrogen level is reduced to, for example, less than or equal to about 20, 15, 10, 5, or less percent by volume. The removal of reactive gases from a carbon particle by degassing the carbon particle can reduce variability in reactivity of different carbon particles. For example, the removal of the reactive gases can provide carbon particles with a same or substantially same reactivity which can, in turn, homogenize downstream reaction conditions. In some cases, the degassing may remove non-reactive gases from the carbon particle. For example, the degassing may remove a process gas (e.g., argon, carbon dioxide, nitrogen, etc.) from the carbon particle.

Examples of morphologies of carbon particles include, but are not limited to, disks, bowls, cones, aggregated disks, few layer graphene (FLG), ellipsoids, aggregated ellipsoids, spheres, aggregated spheres, or the like, or any combination thereof. A plurality of carbon particles may comprise carbon particles of a plurality of morphologies.

In another operation 120, the example method 100 of the present disclosure may comprise adding, to the carbon particle, one or more additives (also referred to herein as an additive package or an additive mixture) comprising one or more of a hydrate, a hydrated salt, a carboxylate salt, a carboxylate, a carboxylic acid, and/or any combination thereof, thereby forming a treated carbon particle.

An additive mixture may comprise one or more hydrates. The hydrate may be or comprise a compound configured to contain water and to release the water during a mixing of a polymer with the carbon particle. Examples of hydrates configured to contain water and release the water during a mixing of a polymer with the carbon particle include, but are not limited to, metal organic frameworks, micelle encapsulated water (e.g., water encapsulated in a micelle comprising a polymer, polymerized urea, and formaldehyde with water therein, etc.), molecular sieves comprising water (e.g., molecular sieves generated in situ, molecular sieves prepared and ground), superabsorbent polymers (e.g., crosslinked polyacrylamide, polyacrylate, maleic anhydride copolymers, cellulose graft copolymers, etc.) or the like, or any combination thereof. For example, a carbon particle surface may be decorated with a hydrate (e.g., a metal organic framework comprising water) and may be subsequently used in a polymer reinforcement reaction. Hydrates may include, for non-limiting example, sodium sulfide nonahydrate, and magnesium sulfate heptahydrate.

An additive mixture may comprise one or more hydrated salts. A hydrated salt additive may be used interchangeably with or in addition to a hydrate of the present disclosure, with similar results. The hydrated salt may be or comprise, for example, a hydrated carboxylate salt (e.g., a hydrated salt of a composition comprising a carboxylate group). Hydrated salts may include, for non-limiting example, sodium acetate trihydrate or sodium maleate. For all ranges of hydrated salts, the amount of the salt present is denoted as a mass percent on the basis of the salt on an anhydrous basis. For other hydrates, the ranges are for the total mass of the hydrate with the water included.

An additive mixture may comprise one or more carboxylate salts. A carboxylate salt may be or comprise any hydrocarbon that possesses a carboxylate or carboxylic acid moiety. A salt of a carboxylic acid, for example, may be any one of a class of organic compounds in which a carbon atom is bonded (i) to an oxygen atom by a double bond and (ii) to a hydroxyl group where the hydrogen atom is replaced by a metal, a metalloid, or the like, and (iii) where the fourth bond of the carbon atom may be to another carbon atom or to a hydrogen atom. The carboxylate salt may comprise an anion (e.g., the carboxylate containing portion of the salt) and a cation (e.g., the one or more counterions of the anion). Examples of carboxylate salt anions include, but are not limited to, citrate, acetate, propionate, oxalate, phthalate, oleate, maleate, malate, sulfanilate, trithiocyanurate, stearate, acrylate, methacrylate, dibutyl phthalate, fumarate, lactate, ethylene diamine tetraacetate, benzoate, aminobenzoate, periodate, polymers comprising carboxylates (e.g., polyacrylate, polybutadiene/maleate copolymer, etc.), or the like. Examples of carboxylate salt cations include, but are not limited to, hydrogen, alkali metals (e.g., lithium, sodium, potassium, rubidium, etc.), alkali earth metals (magnesium, calcium, barium, etc.), tin, zirconium, vanadium, chromium, manganese, iron, cobalt, nickel, zinc, organic cations (e.g., cations comprising carbon), other polyatomic cationic species (e.g., ammonium, tetramethylammonium, trimethylammonium, triethylammonium, tetrabutylammonium, guanidinium, other ammonia species, hydronium, etc.), polycations, or the like.

An additive mixture may comprise one or more carboxylic acids. A carboxylic acid may be any one of a class or organic compounds in which a carbon atom is bonded (i) to an oxygen atom by a double bond and (ii) to a hydroxyl group by a single bond, and (iii) where the fourth bond of the carbon atom may be to another carbon atom or to a hydrogen atom (e.g., as in the case of formic acid). The carboxylate acid may be or comprise, for example, citric acid, acetic acid, propionic acid, oxalic acid, phthalic acid, oleic acid, maleic acid, malic acid, sulfanilic acid, trithiocyanuric acid, stearic acid, acrylic acid, methacrylic acid, dibutyl phthalic acid, fumaric acid, lactic acid, glycolic acid, tannic acid, lignocellulosic acid, ethylene diamine tetraacetic acid, benzoic acid, aminobenzoic acid, periodic acid, and the like. The carboxylic acid may be or comprise, for example, the conjugate acid of the corresponding carboxylate salts listed above wherein the anion is the carboxylate salt and the cation is the positively charged hydrogen ion (H+) moiety.

An additive mixture may comprise one or more additives, each additive of one or more of the aforementioned types (hydrate, hydrated salt, carboxylate salt, carboxylate, carboxylic acid).

The additive mixture further may comprise one or more of a filler (e.g., silica, other carbon particles, etc.), an oil (e.g., an organic oil, a silicon oil, etc.), a metal oxide, (e.g., zinc oxide, titanium oxide, etc.), a peroxide or a reaction product therefrom (e.g., hydrogen peroxide), a sulfur containing compound (e.g., sulfur, a benzenesulfenamide, lignosulfonate, etc.), a vulcanization accelerator (e.g., a thiuram, an organic acid (e.g., stearic acid, etc.), etc.), or the like, or any combination thereof. Other examples of the components of an additive mixture may be found in “The Science and Technology of Rubber” (Mark, Erman, and Roland, Fourth Edition, Academic Press), the disclosure of which is incorporated by reference in its entirety.

In operation 120, the additive mixture may be added to the carbon particle via, for example, addition of a binder comprising the additive mixture. For example, the additive mixture may be suspended or dissolved in water and/or be in the form of an aqueous solution, and the water, additive mixture, and/or aqueous solution can be added to (e.g., contacted with) the carbon particle.

The additive mixture can be added to the carbon particle at a feed bin of a pelletizer, subsequent to a drying of the carbon particle (e.g., using a rotary kiln, a vibratory fluidized bed (VFB) dryer, a fluidized bed dryer, a tray dryer, or the like, or any combination thereof), as a neat spray, as a diluted spray (e.g., diluted with a solvent), or the like, or any combination thereof.

In some cases, operation 120 may comprise adding a pelletizer solution to the carbon particle. The pelletizer solution may be configured to bind the carbon particle to one or more other carbon particles, thereby (e.g., after pelletization operation 130) forming a carbon pellet comprising the carbon particle. The additive mixture may comprise the pelletizer solution. For example, the pelletizer solution may be at least a portion of the additive mixture. In some cases, the pelletizer solution may be added to the carbon particle after the additive mixture. The pelletizer solution may comprise, by way of non-limiting example, water, water soluble binders such as lignosulfonate, sugar, molasses, polysorbate polymers (e.g., Tween® 80, Tween® 20, etc.), polyethylene glycol, or the like, or any combination thereof.

In some cases, the additive mixture may comprise one or more sulfur containing compounds. Examples of sulfur containing compounds include, but are not limited to, organometallic sulfur compounds (e.g., a compound comprising sulfur or a sulfur containing species bound to one or more metal ions), metallic sulfur (e.g., a compound comprising a metal ion bound to a sulfur or sulfur containing ion), polysulfides, sulfides, free sulfur, or the like, or any combination thereof. The sulfur containing compounds may be present at a ratio of at least about 0.01, 0.05, 0.1, 0.2, 0.3, 0.4, 0.5, 0.6, 0.7, 0.8, 0.9, 1, 1.5, 2, 2.5, 3, 3.5, 4, 4.5, 5, 6, 7, 8, 9, 10, 11, 12, 13, 14, 15, 16, 17, 18, 19, 20, or more percent by mass of the total mass of the carbon pellet sample after drying. The sulfur containing compounds may be present at a ratio of at most about 20, 19, 18, 17, 16, 15, 14, 13, 12, 11, 10, 9, 8, 7, 6, 5, 4.5, 4, 3.5, 3, 2.5, 2, 1.5, 1, 0.9, 0.8, 0.7, 0.6, 0.5, 0.4, 0.3, 0.2, 0.1, 0.05, 0.01, or less percent by mass of the total mass of the carbon pellet sample after drying. The sulfur containing compounds may be present in a ratio within a range defined by any two of the preceding values. For example, the sulfur containing compounds may be present at a ratio in a range of about 0.05 to about 0.8 percent by mass. The mass percentage may be a total mass percentage (e.g., mass percentage of a total composition comprising the carbon particles). The mass percentage may be with respect to the carbon particles (e.g., the mass percentage of the one or more hydrates, hydrated salts, carboxylate salts, carboxylates, or carboxylic acids and the carbon particles). For example, an additive mixture may comprise 0.2% sulfur by mass, 0.3% sodium acetate trihydrate by mass, with the remaining mass (e.g., carbon black) at 99.5%, or if there is 0.3% binder, with the remaining mass (e.g., carbon black) at 99.2%. The amount of sulfur containing compound may be similar or substantially similar to the amount of hydrate, hydrated salt, carboxylate salt, carboxylate, or carboxylic acid contained within the additive mixture. The sulfur containing compound can be in the form of one or more molecules, nanoparticles (e.g., particles with a size less than or equal to about 2 micrometer volume equivalent sphere), particles (e.g., particles with a size up to about 10 micrometers, 50 micrometers, 100 micrometers, 150 micrometers, or more), or the like, or any combination thereof.

With continued reference to FIG. 1, in an operation 130, the method 100 may comprise pelletizing the treated carbon particle to generate a carbon pellet. For example, the pelletizing may be a process by which a plurality of treated carbon particles (e.g., in the form of a fluffy carbon powder) may be transformed or agglomerated into a larger mass particle or carbon pellet. The pelletizing may comprise use of one or more of heat, pressure, vacuum, or the like, or any combination thereof. The pelletizing may be performed at a temperature of at least about 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, or more degrees Celsius (° C.). The pelletizing may be performed at a temperature of at most about 400, 390, 380, 370, 360, 350, 340, 330, 320, 310, 300, 290, 280, 270, 260, 250, 240, 230, 220, 210, 200, 190, 180, 170, 160, 150, 140, 130, 120, 110, 100, 95, 90, 85, 80, 75, 70, 65, 60, 55, 50, 45, 40, 35, 30, 25, 20, or less ° C. The pelletizing may occur at a temperature in a range defined by any two of the preceding values. For example, the pelletizing may occur at a temperature in a range from about 40° C. to about 300° C.

The pelletizing 130 may comprise use of a pelletizer. The pelletizer may comprise a pin agglomerator. The pin agglomerator may have one or more (e.g., two) pens or injectors of liquid. Using the one or more pens or injectors of liquid, a superabsorbent polymer can be synthesized on the surface of the carbon particle in the pin agglomerator. For example, in a first pen, a monomer (e.g., sodium acrylate) can be present and, in a second pen, an initiator (e.g., ammonium persulfate) and a crosslinker (e.g., N,N′-methylenebisacrylamide) can be injected. In this example, the reaction to form the superabsorbent polymer (e.g., superabsorbent crosslinked polyacrylamide) can occur at the surface of the carbon particle.

The preparation of the superabsorbent polymer at the surface of the carbon particle or plurality of carbon particles can provide the carbon pellet with a moisture content of at least about 0.01, 0.05, 0.1, 0.2, 0.3, 0.4, 0.5, 0.6, 0.7, 0.8, 0.9, 1, 1.5, 2, 2.5, 3, 3.5, 4, 4.5, 5, or more percent.

Subsequent to pelletization, the carbon pellet may be dried. In an operation 140, the method 100 may comprise drying the carbon pellet to a moisture content of at least about 0.2% and at most about 5%. The drying operation 140 may comprise use of, for example, a rotary kiln, a vibratory fluidized bed dryer, a fluidized bed dryer, a tray dryer, or the like, or any combination thereof. The drying may comprise use of an oven. The drying (e.g., oven drying, fluidized bed drying, etc.) may occur at a temperature of at least about 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, or more degrees Celsius (C). The drying may occur at a temperature of at most about 250, 240, 230, 220, 210, 200, 190, 180, 170, 160, 150, 140, 130, 120, 110, 100, 95, 90, 85, 80, 75, 70, 65, 60, 55, 50, 45, 40, 35, 30, or less ° C. The drying may occur at a temperature in a range as defined by any two of the preceding values. For example, the drying may occur at a temperature in a range of about 50° C. to about 80° C. For another example, the drying may occur at a temperature in a range of about 100° C. to about 250° C.

The drying of the carbon pellet 140 may improve the performance of the generated carbon pellet 130 in an elastomer reinforcement process 150. For example, in some cases, the drying of the carbon pellet (e.g., to a moisture content of less than or equal to about 5%) may contribute to improved performance of the carbon pellet in an elastomer reinforcement process. In other cases, the drying of the carbon pellet 140 may have no effect on or may decrease the performance of the generated carbon pellet 130 in an elastomer reinforcement process 150. For example, the overdrying of the carbon pellet (e.g., to a moisture content of less than about 0.2%) may remove almost all of the water from the pellet, which can decrease the performance of the pellet in an elastomer reinforcement process.

The carbon pellet may have a bed temperature (e.g., a temperature of the carbon pellet directly after pelletization 130) of at least about 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, or more degrees Celsius (°C). The carbon pellet may have a bed temperature of at most about 250, 240, 230, 220, 210, 200, 190, 180, 170, 160, 150, 140, 130, 120, 110, 100, 95, 90, 85, 80, 75, 70, 65, 60, 55, 50, 45, 40, 35, 30, or less ° C. The bed temperature may be a temperature in a range as defined by any two of the preceding values. For example, the bed temperature can be in a range from about 50° C. to about 120° C. A bed temperature can be measured through the immediate piling of the carbon pellets after pelletization 130 and an insertion of a thermocouple into the pile. A vibratory fluidized bed (VFB) dryer can operate at a bed temperature in a range of about 45° C. to about 90° C., with an incoming hot air stream at a temperature in a range of about 200° C. to about 500° C. The hot air stream can be moved through the vibrating bed via small holes disposed throughout the bed, thereby increasing the amount of water that can be removed from the carbon pellets while maintaining a lower overall temperature (e.g., less than about 120° C.).

In some cases, subsequent to pelletization operation 130 and drying operation 140, the method 100 may comprise using the carbon pellet in an elastomer reinforcement process 150. For example, the carbon pellet may be a reagent in the preparation of a reinforced elastomer. In this example, the material properties of the elastomer can be changed by the presence of the carbon pellet and the reinforcement process. For example, the elastomer reinforcement process may comprise rubber vulcanization. For example, the carbon pellet may be compounded into a rubber to generate a vulcanized rubber. Many types of elastomers are amenable to reinforcement using the methods and additives of the present disclosure, as described further below.

In optional operation 150 of example method 100, the carbon pellet of the present disclosure may be mixed with an elastomer (e.g., as a portion of an elastomer reinforcement reaction). The mixing of the carbon pellet with the elastomer may result in an increased temperature of the elastomer/pellet mixture. For example, use of a mechanical mixer can generate heat during mixing due to, for example, the mechanical forces applied to the elastomer, friction of mixing, etc. The mixing of the carbon pellet with the elastomer can occur at a temperature of at least about 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, or more degrees Celsius (° C.). The mixing of the carbon pellet with the elastomer can occur at a temperature of at most about 400, 390, 380, 370, 360, 350, 340, 330, 320, 310, 300, 290, 280, 270, 260, 250, 240, 230, 220, 210, 200, 190, 180, 170, 160, 150, 140, 130, 120, 110, 100, 95, 90, 85, 80, 75, 70, 65, 60, 55, 50, 45, 40, 35, 30, 25, 20, or less ° C. The mixing of the carbon pellet with the elastomer can occur at a temperature in a range as defined by any two of the preceding values. For example, the mixing of the carbon pellet with the elastomer can occur at a temperature in a range from about 80° C. to about 200° C. The increased temperature of the mixing may result in a release of at least a portion of the water contained within the carbon pellet from the additive mixture added to the carbon particle 120 before pelletization 130 and drying 140. While FIG. 1 shows operational steps in an order, the operational steps may be combined and/or performed in an alternative order.

In an example, water may be used to pelletize 130 a carbon particle (e.g., carbon black). The additive package may be mixed 120 into water and dissolved or dispersed (e.g., if colloidal sulfur). The water and the additive package dissolved or dispersed therein then may be sprayed 120 onto the carbon particle in a pin agglomerator. The pin agglomerator may be utilized to pelletize 130 the carbon particle, which may change a pour density of the carbon particles (e.g., from about 100 kg/m3 to about 300 or 400kg/m3 ). The wet carbon pellets may be dried 140 and the water removed in substantial part after the additive package has been added and is finely distributed across the carbon particle surface. The release of the water can provide enhanced local concentrations of moisture in the elastomer-carbon pellet mixture and can result in improved performance of the carbon pellet (and thereby the carbon particle) in the elastomer reinforcement process 150.

The elastomer reinforcement process 150 may comprise a mixing at an elevated (e.g., above ambient) temperature and a curing of the elastomer at an elevated temperature.

The elevated temperature may be a temperature of at least about 20, 25, 30, 35, 40, 45, 50, 55, 60, 65, 70, 75, 80, 85, 90, 95, 100, 110, 120, 130, 140, 150, 160, 170, 180, 190, 200, or more degrees Celsius (°C). The elevated temperature may be a temperature of at most about 400, 390, 380, 370, 360, 350, 340, 330, 320, 310, 300, 290, 280, 270, 260, 250, 240, 230, 220, 210, 200, 190, 180, 170, 160, 150, 140, 130, 120, 110, 100, 95, 90, 85, 80, 75, 70, 65, 60, 55, 50, 45, 40, 35, 30, or fewer less ° C. The elevated temperature may be a temperature in a range as defined by any two of the preceding values. For example, the elevated temperature may be a temperature in a range of about 80° C. to about 200° C.

The mixing in the elastomer reinforcement process 150 may include, without limitation, use of hydrophilic acids as preferable to hydrophobic acids or acid salts. For example, during mixing, a salt may melt, and an extremely hydrophobic salt may dissolve into the elastomer matrix. This may cause the enhanced crosslinking to not occur at the carbon particle surface, but rather throughout the rubber mixture. Enhanced crosslinking at the rubber surface may improve performance, and acids or salts such as glycolic acid, formic acid, acetic acid may be preferable for this purpose due to their strong hydrophilicity which is incompatible with the hydrophobic elastomer system.

The methods of the present disclosure (e.g., example method 100) may be carried out in an inert atmosphere. The inert atmosphere may comprise low, substantially no, or no reactive gas species. For example, the method 100 may be carried out in a substantially nitrogen atmosphere. The method 100 may be carried out in an atmosphere comprising at most about 50%, 45%, 40%, 35%, 30%, 25%, 20%, 15%, 10%, 9%, 8%, 7%, 6%, 5%, 4%, 3%, 2%, 1%, 0.5%, 0.1%, 0.05%, 0.01%, 0.005%, 0.004%, 0.003%, 0.002%, 0.001%, 9 parts per million (ppm), 8 ppm, 7 ppm, 6 ppm, 5 ppm, 4 ppm, 3 ppm, 2 ppm, 1 ppm, or less oxygen by mole fraction.

In some cases, the present disclosure provides a carbon particle (e.g., a treated, pelletized, and dried carbon particle) or carbon pellet comprising a plurality of carbon particles. The carbon particle may comprise a surface decorated with one or more hydrates, hydrated salts, carboxylate salts, carboxylates, or carboxylic acids, as described elsewhere herein.

The one or more hydrates, hydrated salts, carboxylate salts, carboxylates, or carboxylic acids may be present at a cumulative ratio (if more than one) of at least about 0.01, 0.05, 0.1, 0.2, 0.3, 0.4, 0.5, 0.6, 0.7, 0.8, 0.9, 1, 1.5, 2, 2.5, 3, 3.5, 4, 4.5, 5, 6, 7, 8, 9, 10, 11, 12, 13, 14, 15, 16, 17, 18, 19, 20, or more percent by mass. The one or more hydrates, hydrated salts, carboxylate salts, carboxylates, or carboxylic acids may be present at a cumulative ratio (if more than one) of at most about 20, 19, 18, 17, 16, 15, 14, 13, 12, 11, 10, 9, 8, 7, 6, 5, 4.5, 4, 3.5, 3, 2.5, 2, 1.5, 1, 0.9, 0.8, 0.7, 0.6, 0.5, 0.4, 0.3, 0.2, 0.1, 0.05, 0.01, or less percent by mass. The one or more hydrates, hydrated salts, carboxylate salts, carboxylates, or carboxylic acids may be present in a ratio within a range defined by any two of the preceding values. For example, the one or more hydrates, hydrated salts, carboxylate salts, carboxylates, or carboxylic acids may be present in a ratio in a range of about 0.05 to about 0.8 percent by mass. The mass percentage may be a total mass percentage (e.g., mass percentage of a total composition comprising the carbon particles). The mass percentage may be with respect to the carbon particles (e.g., the mass percentage of the one or more hydrates, hydrated salts, carboxylate salts, carboxylates, or carboxylic acids and the carbon particles).

The one or more hydrates, hydrated salts (e.g., hydrated carboxylate salt), carboxylate salts, carboxylates, or carboxylic acids may increase a hydrophilic spreading pressure of the carbon particle of a carbon pellet comprising a plurality of such carbon particles when compared to the carbon particle without the one or more hydrates, hydrated salts, carboxylate salts, carboxylates, or carboxylic acids. For example, a carbon particle of a carbon pellet with the one or more hydrates, hydrated salts, carboxylate salts, carboxylates, or carboxylic acids may have a higher hydrophilic spreading pressure than the same carbon particle that was not decorated with the one or more additive(s). The hydrophilic spreading pressure of the carbon particle may be increased by at least about 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 110, 120, 130, 140, 150, or more percent with addition of the one or more hydrates, hydrated salts (e.g., hydrated carboxylate salt), carboxylate salts, carboxylates, or carboxylic acids. The hydrophilic spreading pressure of the carbon particle may be increased by at most about 150, 140, 130, 120, 110, 100, 95, 90, 85, 80, 75, 70, 65, 60, 55, 50, 45, 40, 35, 30, 25, 20, 19, 18, 17, 16, 15, 14, 13, 12, 11, 10, 9, 8, 7, 6, 5, 4, 3, 2, 1, or less percent with addition of the one or more hydrates, hydrated salts, carboxylate salts, carboxylates, or carboxylic acids. The hydrophilic spreading pressure of the carbon particle may be increased by an amount within a range as defined by any two of the preceding values. For example, the hydrophilic spreading pressure of the carbon particle may be increased by an amount in a range of about 10 percent to about 50 percent with addition of the one or more hydrates, hydrated salts, carboxylate salts, carboxylates, or carboxylic acids.

The one or more hydrates, hydrated salts, carboxylate salts, carboxylates, or carboxylic acids may be configured to release water upon an elevation of the temperature of the carbon particle. For example, the one or more hydrates, hydrated salts, carboxylate salts, carboxylates, or carboxylic acids can be decorating the surface of a carbon particle and, upon heating of the carbon particle, release the water from the one or more hydrates, hydrated salts, carboxylate salts, carboxylates, or carboxylic acids into an area surrounding the carbon particle. In this example, the released water can be made available as a reactive reagent in the area immediately around the carbon particle. The elevation of temperature to release the water can be performed during an elastomer reinforcement process as described elsewhere herein. For example, a carbon particle decorated with one or more hydrates, hydrated salts, carboxylate salts, carboxylates, or carboxylic acids may be incorporated in a rubber mixing process. In this example, during a heating operation of the rubber mixing process, the water of the one or more hydrates, hydrated salts, carboxylate salts, carboxylates, or carboxylic acids may be released from the one or more hydrates, hydrated salts, carboxylate salts, carboxylates, or carboxylic acids and take part in the rubber mixing process proximal to the carbon particle.

The present disclosure may provide a carbon pellet comprising a plurality of carbon particles comprising a carbon particle decorated with one or more hydrates, hydrated salts, carboxylate salts, carboxylates, or carboxylic acids. The other carbon particles of the plurality of carbon particles may be the same or substantially the same as the carbon particle. For example, the carbon particles of the plurality of carbon particles may all belong to a same grade of carbon particles. In this example, the properties of the carbon particles may all fall within a range of characteristics or parameter values provided by the grade of the carbon particles.

The plurality of carbon particles may comprise at least about 10, 20, 30, 40, 50, 60, 70, 80, 90, 95, 99, 99.9, or more percent carbon particles with a volume equivalent sphere diameter of less than about 2 micrometers (also referred to as nanoparticles herein). The plurality of carbon particles may comprise at most about 99.9, 99, 95, 90, 80, 70, 60, 50, 40, 30, 20, 10, or less percent carbon particles with a volume equivalent sphere diameter of less than about 2 micrometers. The plurality of carbon particles may comprise a percentage of carbon particles with a volume equivalent sphere diameter of less than about 2 micrometers in a range defined by any two of the preceding values. For example, the plurality of carbon particles may comprise from about 85 to about 99 percent carbon particles with a volume equivalent sphere diameter of less than about 2 micrometers. The volume equivalent sphere diameter may be measured by centrifugal particle sedimometry. An example of volume equivalent sphere diameter determination can be found in the book “Principles of Colloid and Surface Chemistry” (Hiemenz, Rajagopalan, Third Edition, pp. 70-78 for the volume equivalent sphere diameter determination), which is incorporated by reference in its entirety.

In some cases, the carbon pellet may comprise a binder. The binder may be as described elsewhere herein. For example, the binder may be lignosulfonate. In some cases, the one or more hydrates, hydrated salts, carboxylate salts, carboxylates, or carboxylic acids can be hydrated by the binder or an aqueous carrier solution (e.g., water) of the binder. For example, the one or more hydrates, hydrated salts, carboxylate salts, carboxylates, or carboxylic acids can become hydrated upon exposure to a binder solution comprising water. In some cases, the one or more hydrates, hydrated salts, carboxylate salts, carboxylates, or carboxylic acids can be hydrated prior to exposure to the binder or the carrier solution. For example, the one or more hydrates, hydrated salts, carboxylate salts, carboxylates, or carboxylic acids can be hydrated when applied to the carbon particle prior to an introduction of the binder carrier solution.

The carbon pellet may have a moisture (e.g., water) content of at least about 0.001, 0.005, 0.01, 0.05, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.5, 4, 4.5, 5, 6, 7, 8, 9, 10, or more percent by mass. The carbon pellet may have a moisture content of at most about 10, 9, 8, 7, 6, 5, 4.5, 4, 3.5, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, 0.1, 0.05, 0.01, 0.005, 0.001, or less percent by mass. The carbon pellet may have a moisture content in a range as defined by any two of the preceding values. For example, the carbon pellet may have a moisture content in a range of about 0.1 to about 1.5 percent by mass. In another example, the carbon pellet may have a moisture content of about 0.2 to about 1 percent by mass. The moisture content of the pellet may be due to the water contained within the one or more hydrates, hydrated salts, carboxylate salts, carboxylates, or carboxylic acids. For example, all or substantially all of the moisture content of the carbon pellet may be contained within the one or more hydrates, hydrated salts, carboxylate salts, carboxylates, or carboxylic acids. The moisture content of the carbon pellet may be substantially due to water or aqueous mixtures contained within the one or more hydrates, hydrated salts, carboxylate salts, carboxylates, or carboxylic acids. The moisture content of the carbon pellet may be due to a combination of the moisture contained within the one or more hydrates, hydrated salts, carboxylate salts, carboxylates, or carboxylic acids and moisture contained in different components of the carbon pellet.

A carbon particle of a carbon pellet after drying step 140 may have a surface area of at least about 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, or more square meters per gram (m²/g). The carbon particle may have a surface area of at most about 400, 390, 380, 370, 360, 350, 340, 330, 320, 310, 300, 290, 280, 270, 260, 250, 240, 230, 220, 210, 200, 190, 180, 170, 160, 150, 140, 130, 120, 110, 100, 95, 90, 85, 80, 75, 70, 65, 60, 55, 50, 45, 40, 35, 30, 25, 20, 19, 18, 17, 16, 15, 14, 13, 12, 11, 10, 9, 8, 7, 6, 5, 4, 3, 2, 1, or fewer square meters per gram (m^{2/}g). The carbon particle may have a surface area in a range as defined by any two of the preceding values. For example, the carbon particle may have a surface area in a range of about 15 m²/g to about 50 m²/g. The surface area may be a nitrogen surface area (N2SA), a statistical thickness surface area (STSA), an electron microscopy surface area (EMSA), or the like.

A carbon particle of a carbon pellet after drying step 140 may comprise at least about 50, 55, 60, 65, 70, 75, 80, 85, 90, 91, 92, 93, 94, 95, 96, 97, 98, 99, 99.5, 99.9, 99.99, or more percent carbon by mass. The carbon particle may comprise at most 99.99, 99.9, 99.5, 99, 98, 97, 96, 95, 94, 93, 92, 91, 90, 85, 80, 75, 70, 65, 60, 55, 50, or less percent carbon by mass. The carbon particle may comprise an amount of carbon within a range as defined by any two of the preceding values. For example, the carbon particle may comprise carbon in a range from about 90 to about 99 percent carbon by mass.

A carbon particle of a carbon pellet after drying step 140 may have a volume equivalent sphere diameter of at least about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, or more micrometers. The carbon particle may have a volume equivalent sphere diameter of at most about 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, 0.1, or less micrometers. The carbon particle may have a volume equivalent sphere diameter in a range as defined by any two of the preceding values. For example, the carbon particle may have a volume equivalent sphere diameter in a range from about 1 micrometer to about 2 micrometers. In another example, the carbon particle may have a volume equivalent sphere diameter in a range from about 100 nanometers to about 700 nanometers.

The carbon particle may have a ratio of carbon-12 atoms to carbon-14 atoms of at least about 1:10⁻²⁰, 1:10⁻¹⁹, 1:10⁻¹⁸, 1:10⁻¹⁷, 1:10⁻¹⁶, 1:10⁻¹⁵, 1:10⁻¹⁴, 1:10⁻¹³, 1:2×10⁻¹³, 1:3×10⁻¹³, 1:4×10⁻¹³, 1:5×10⁻¹³, 1:6×10⁻¹³, 1:7×10⁻¹³, 1:8×10⁻¹³, 1:9×10⁻¹³, 1:10⁻¹², 1:1.1×10⁻¹², 1:1.2×10⁻¹², 1:1.3×10⁻¹², 1:1.35×10⁻¹², 1:1.4×10⁻¹², or more. The carbon particle may have a ratio of carbon-12 atoms to carbon-14 atoms of at most about 1:1.4×10⁻¹², 1:1.35×10⁻¹², 1:1.310⁻¹², 1:1.2×10⁻¹², 1:1.1×10⁻¹², 1:10⁻¹², 1:9×10⁻¹³, 1:8×10⁻¹³, 1:7×10⁻¹³, 1:6×10⁻¹³, 1:5×10⁻¹³, 1:4×10⁻¹³, 1:3×10⁻¹³, 1:2×10⁻¹³, 1:10⁻¹³, 1:10⁻¹⁴, 1:10⁻¹⁵, 1:10⁻¹⁶, 1:10⁻¹⁷, 1:10⁻¹⁸, 1:10⁻¹⁹, 1:10⁻²⁰, or less. The carbon particle may have a ratio of carbon-12 to carbon-14 atoms in a range as defined by any two of the preceding values. For example, the carbon particle may have a ratio of carbon-12 to carbon-14 atoms in a range of about 1:10⁻¹⁴ to about 1:1.5×10⁻¹³.

The present disclosure may provide a composite comprising an elastomer and a carbon particle of a carbon pellet. The composite may comprise the elastomer and the carbon pellet comprising the carbon particle. The composite may be a reinforced elastomer comprising the elastomer and the carbon particle. For example, the elastomer may be reinforced at least in part by the carbon particle. The elastomer reinforced with the carbon particle decorated with one or more hydrates, hydrated salts, carboxylate salts, carboxylates, or carboxylic acids may have an improvement in the performance properties of the elastomer composite of at least about 0.5, 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, 100, or more percent as compared to an elastomer composite that is formed with carbon particles that do not have a surface decorated with the one or more hydrates, hydrated salts, carboxylate salts, carboxylates, or carboxylic acids. Examples of material properties that can be improved with addition of the one or more hydrates, hydrated salts, carboxylate salts, carboxylates, or carboxylic acids include, but are not limited to, tensile strength, tear resistance, abrasion resistance, elastic modulus (e.g., M100, M300, and/or ratios thereof, etc.), or the like. For example, an elastomer composite reinforced with a carbon particle decorated with one or more hydrates, hydrated salts, carboxylate salts, carboxylates, or carboxylic acids may provide a performance increase in the modulus at 300% elongation (M300) and/or the ratio of the modulus at 300% elongation to the modulus at 100% elongation (M300/M100).

Carbon particles decorated with one or more hydrates, hydrated salts, carboxylate salts, carboxylates, or carboxylic acids may lose performance when heated to temperatures above about 200 degrees Celsius, while similar heating may not impact the performance of a carbon particle not decorated with one or more hydrates, hydrated salts, carboxylate salts, carboxylates, or carboxylic acids. For example, the performance of a first carbon particle that has been decorated with one or more hydrates, hydrated salts, carboxylate salts, carboxylates, or carboxylic acids and heated to 200 degrees Celsius or more can be lower than a second carbon particle that was not decorated with one or more hydrates, hydrated salts, carboxylate salts, carboxylates, or carboxylic acids and heated to the same temperature. In this example, the first carbon particle may be a carbon particle generated by a plasma process, and the second carbon particle may be a carbon particle generated by a furnace process. In another example, the first carbon particle may be a carbon particle generated 110 in a system comprising a Flow Straightener (see Int. Pat. App. No. PCT/US2023/077402, incorporated by reference above), while the second carbon particle may be a carbon particle generated in a system that does not comprise a Flow Straightener. In another example, the first carbon particle may be a carbon particle generated 110 in a system comprising a Flow Straightener, treated with an additive mixture 120, pelletized 130, and overdried 140 to a moisture content of below about 0.2%, while the second carbon particle may be a carbon particle generated 110 in a system comprising a Flow Straightener, treated with an additive mixture 120, pelletized 130, and dried 140 to a moisture content in a range of about 0.2% to about 5%.

Examples of elastomers amenable to reinforcement using the methods and additives of the present disclosure include, but are not limited to, natural rubbers, styrene butadiene rubber, polybutadiene, polyisobutylene, polyisoprene, nitrile rubber, butyl rubber, halobutyl, ethylene propylene rubber, ethylene propylene diene rubber, silicone rubber, fluoroelastomers, or the like, or any combination thereof. Other examples of elastomers may be found in “The Science and Technology of Rubber” (Mark, Erman, and Roland, Fourth Edition, Academic Press), incorporated by reference above. The elastomer may be a polymer related to natural rubber. The elastomer may have both viscous and elastic components. The elastomer also may be a chemically modified rubber, for example (but not limited to) end groups that have been carboxylated, epoxidized, etc. The middle, beginning, and end of the elastomer chain, and anywhere between, are all areas where elastomer chain modification with chemical moieties may be performed.

Systems and methods of the present disclosure may be combined with or modified by other systems and/or methods (with appropriate modification(s)), such as, for example, chemical processing and heating methods, chemical processing systems, reactors and plasma torches described in U.S. Pat. Pub. No. US 2015/0210856 and Int. Pat. Pub. No. WO 2015/116807 (“SYSTEM FOR HIGH TEMPERATURE CHEMICAL PROCESSING”), U.S. Pat. Pub. No. US 2015/0211378 (“INTEGRATION OF PLASMA AND HYDROGEN PROCESS WITH COMBINED CYCLE POWER PLANT, SIMPLE CYCLE POWER PLANT AND STEAM REFORMERS”), Int. Pat. Pub. No. WO 2015/116797 (“INTEGRATION OF PLASMA AND HYDROGEN PROCESS WITH COMBINED CYCLE POWER PLANT AND STEAM REFORMERS”), U.S. Pat. Pub. No. US 2015/0210857 and Int. Pat. Pub. No. WO 2015/116798 (“USE OF FEEDSTOCK IN CARBON BLACK PLASMA PROCESS”), U.S. Pat. Pub. No. US 2015/0210858 and Int. Pat. Pub. No. WO 2015/116800 (“PLASMA GAS THROAT ASSEMBLY AND METHOD”), U.S. Pat. Pub. No. US 2015/0218383 and Int. Pat. Pub. No. WO 2015/116811 (“PLASMA REACTOR”), U.S. Pat. Pub. No. US 2015/0223314 and Int. Pat. Pub. No. WO 2015/116943 (“PLASMA TORCH DESIGN”), Int. Pat. Pub. No. WO 2016/126598 (“CARBON BLACK COMBUSTABLE GAS SEPARATION”), Int. Pat. Pub. No. WO 2016/126599 (“CARBON BLACK GENERATING SYSTEM”), Int. Pat. Pub. No. WO 2016/126600 (“REGENERATIVE COOLING METHOD AND APPARATUS”), U.S. Pat. Pub. No. US 2017/0034898 and Int. Pat. Pub. No. WO 2017/019683 (“DC PLASMA TORCH ELECTRICAL POWER DESIGN METHOD AND APPARATUS”), U.S. Pat. Pub. No. US 2017/0037253 and Int. Pat. Pub. No. WO 2017/027385 (“METHOD OF MAKING CARBON BLACK”), U.S. Pat. Pub. No. US 2017/0058128 and Int. Pat. Pub. No. WO 2017/034980 (“HIGH TEMPERATURE HEAT INTEGRATION METHOD OF MAKING CARBON BLACK”), U.S. Pat. Pub. No. US 2017/0066923 and Int. Pat. Pub. No. WO 2017/044594 (“CIRCULAR FEW LAYER GRAPHENE”), U.S. Pat. Pub. No. US 2017/0073522 and Int. Pat. Pub. No. WO 2017/048621 (“CARBON BLACK FROM NATURAL GAS”), Int. Pat. Pub. No. WO 2017/190045 (“SECONDARY HEAT ADDITION TO PARTICLE PRODUCTION PROCESS AND APPARATUS”), Int. Pat. Pub. No. WO 2017/190015 (“TORCH STINGER METHOD AND APPARATUS”), Int. Pat. Pub. No. WO 2018/165483 (“SYSTEMS AND METHODS OF MAKING CARBON PARTICLES WITH THERMAL TRANSFER GAS”), Int. Pat. Pub. No. WO 2018/195460 (“PARTICLE SYSTEMS AND METHODS”), Int. Pat. Pub. No. WO 2019/046322 (“PARTICLE SYSTEMS AND METHODS”), Int. Pat. Pub. No. WO 2019/046320 (“SYSTEMS AND METHODS FOR PARTICLE GENERATION”), Int. Pat. Pub. No. WO 2019/046324 (“PARTICLE SYSTEMS AND METHODS”), Int. Pat. Pub. No. WO 2019/084200 (“PARTICLE SYSTEMS AND METHODS”), Int. Pat. Pub. No. WO 2019/195461 (“SYSTEMS AND METHODS FOR PROCESSING”), Int. Pat. Pub. No. WO 2022/076306 (“SYSTEMS AND METHODS FOR PROCESSING”), Int. Pat. Pub. No. WO 2023/059520 (“SYSTEMS AND METHODS FOR ELECTRIC PROCESSING”), Int. Pat.

Pub. No. WO 2023/137120 (“METHODS AND SYSTEMS FOR USING SILICON-CONTAINING ADDITIVES TO PRODUCE CARBON PARTICLES”), and Int. Pat. App. No. PCT/US2023/0241148 (“RECYCLED FEEDSTOCKS FOR CARBON AND HYDROGEN PRODUCTION”), each of which is incorporated herein by reference in its entirety.

The following examples are illustrative of certain methods and additives described herein and are not intended to be limiting.

### EXAMPLE

Reinforcement properties of carbon particles decorated with one or more hydrates, hydrated salts, carboxylate salts, carboxylates, and/or carboxylic acids.

Samples of carbon black generated by furnace process (furnace black), and samples of carbon black generated by plasma reactor (Plasma Black), were (i) treated with example surface modification additive packages, and (ii) dried under various drying conditions.

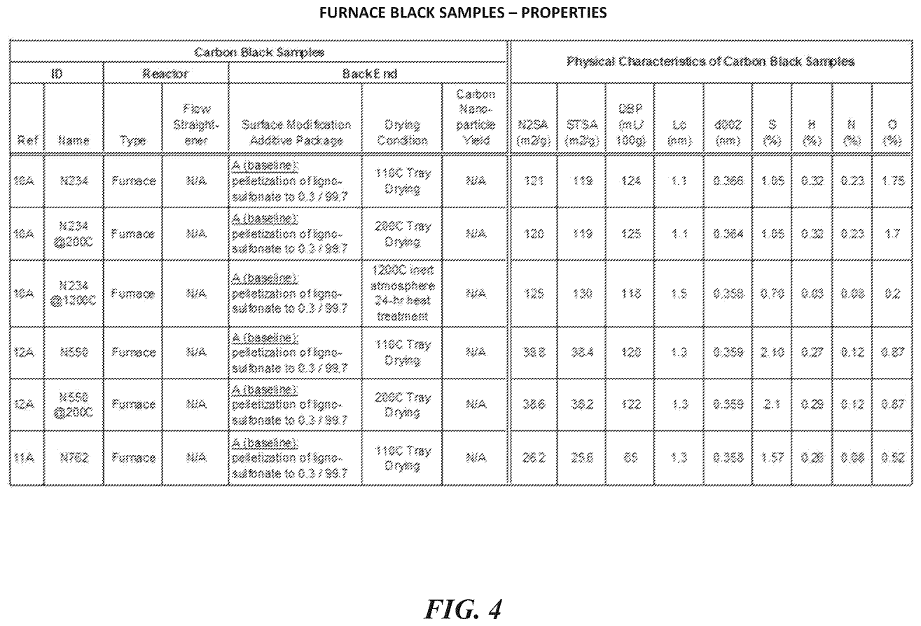

FIG. 4 is a table showing various measured physical properties of various furnace black samples treated with a surface modification additive package and dried under various conditions, according to one or more embodiments of the present disclosure. The furnace black samples are samples of commercial carbon black grades N234, N550, and N762. These furnace black samples were made via furnace process with a heavy oil. Back-end treatment was then applied, as indicated in the Back End columns of FIG. 4. First, all furnace black samples were treated with a Surface Modification Additive Package identified as Baseline “A”: pelletization of lignosulfonate, wherein pelletization occurs such that once the carbon black has been dried, the carbon black possesses 0.3% lignosulfonate and 99.7% carbon, i.e., the ratio of mass percent of the resultant carbon black pellet is 0.3/99.7. Next, all furnace black samples were dried under a Drying Condition, as indicated. One furnace black sample was heat treated in an inert atmosphere at 1200° C.: 10A-N234@1200C. Some furnace black samples were tray dried at 110° C.: 10A-N234, 12A-N550, and 11A-N762. Some furnace black samples were tray dried at 200° C.: 10A-N234@200C and 12A-N550@200C.

Physical characteristics of the furnace black carbon pellets were then measured.

The physical characteristics measured are nitrogen surface area (N2SA) and statistical thickness surface area (STSA), as measured by ASTM D6556-10, the dibutyl phthalate (DBP) absorption as measured by ASTM D2412-12, the crystallinity of the carbon particle (L_{c}) and analysis of the 002 peak of graphite (d₀₀₂) as measured by x-ray diffractometry (e.g., using copper K_{α} at a voltage of 40 kilovolts, a current of 44 milliamps, a scan rate of 1.3 degrees per minute from 2Θ of 12 to 90 degrees) as analyzed by the Scherrer equation (with larger L_{c} values corresponding with greater crystallinity and smaller d₀₀₂ values corresponding to higher crystallinity and more graphitic structure, with d₀₀₂ values of greater than about 0.355 being indicative of turbostratic carbon), and elemental analysis of sulfur (S), hydrogen (H), nitrogen (N), and oxygen (O) determined by atomic absorption spectroscopy. Resulting data are as shown.

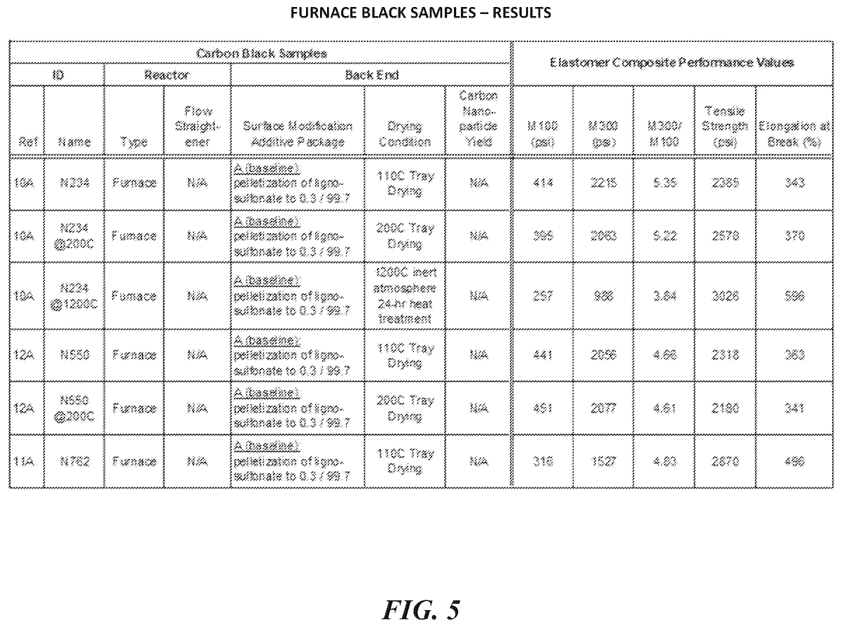

FIG. 5 is a table showing various measured performance properties of elastomer composites made using the furnace blacks of FIG. 4, according to one or more embodiments of the present disclosure. The elastomer composites were prepared using the identified furnace blacks and styrene butadiene rubber specimens prepared according to ASTM D3191. For each sample, the elastomer composite was generated in a same way, allowing for comparison of the values. The elastomer composite performance values measured are elastic modulus M100 (modulus at 100% elongation of an elastomer sample reinforced with the corresponding furnace black carbon particles), elastic modulus M300 (modulus at 300% elongation of an elastomer sample reinforced with the corresponding furnace black carbon particles), tensile strength, and elongation at break as measured by ASTM D412. The performance property M300/M100 was determined by dividing the M300 value by the M100 value for the sample.

The properties of FIG. 4 underscore the importance of carbon particle crystallinity and surface activity. For example, through the heat treatment of the 10A-N234@1200 sample to 1200° C., the reinforcement capability of the carbon black has been substantially reduced.

The hydrogen content (H) of the 10A-N234@1200 sample is lower, and the crystallinity (Lc) is higher, than the other furnace black samples having no heat treatment and tray dried at 110° C. or 200° C. Both of these factors point to lower performance of the carbon black as a reinforcing agent. See, for example, “The Science and Technology of Rubber” (Mark, Erman, and Roland, Fourth Edition, Academic Press), incorporated by reference above. Specifically, the elastic modulus M300 has decreased from 2215 psi (10A-N234) to 988 psi (10A-N234@1200C), and the elongation at break has increased from 343% (10A-N234) to 596% (10A-N234@1200C). indicating that the elastomer composite test specimen with the heat treated 10A-N234@1200C furnace black sample behaves almost as though there were no carbon black present: not stiff, and as the raw rubber gum would behave in terms of ability to stretch and the force required to pull the specimen to three times the original length. The increased crystallinity Lc, decreased d002, and decreased hydrogen content all indicate a less active surface, even though the N2SA and DBP are substantially unchanged.

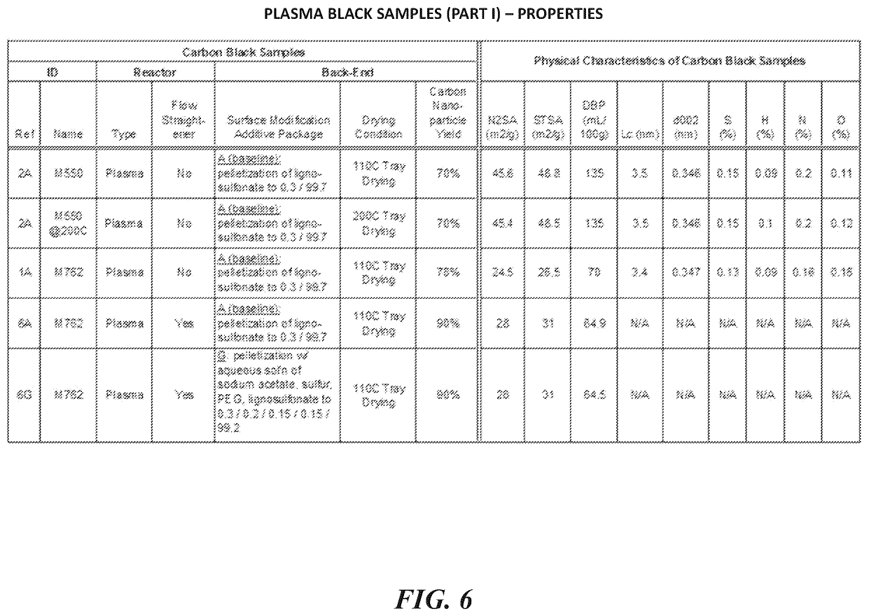

FIGS. 6, 7, and 8 are tables showing various measured physical properties of Plasma Black samples of Monolith® carbon black grades M550 and M762. The M762 samples (referenced in the tables as Groups 6 and 8) were produced at a rate of greater than about 800 kilograms/hour, representing a full-scale production of these carbon particles.

After generation of the carbon particles, back-end treatment was applied, as indicated in the Back End table columns. As shown in FIGS. 6-8, all Plasma Black samples were treated with a Surface Modification Additive Package: Baseline “A” (pelletization of lignosulfonate, wherein pelletization occurs such that once the carbon black has been dried, the carbon black possesses 0.3% lignosulfonate and 99.7% carbon, i.e., the ratio of mass percent of the resultant carbon black pellet is 0.3/99.7), “F” (pelletization with an aqueous solution of sodium acetate, sulfur, and lignosulfonate such that the ratio of mass percent of the resultant carbon black pellet is 0.3/0.2/0.3/99.2), “G” (pelletization with an aqueous solution of sodium acetate, sulfur, PEG, and lignosulfonate such that the ratio of mass percent of the resultant carbon black pellet is 0.3/0.2/0.15/0.15/99.2), or “H” (pelletization and drying but with no binder and no additive in the pelletization solution such that the product after drying is 100% native carbon black).

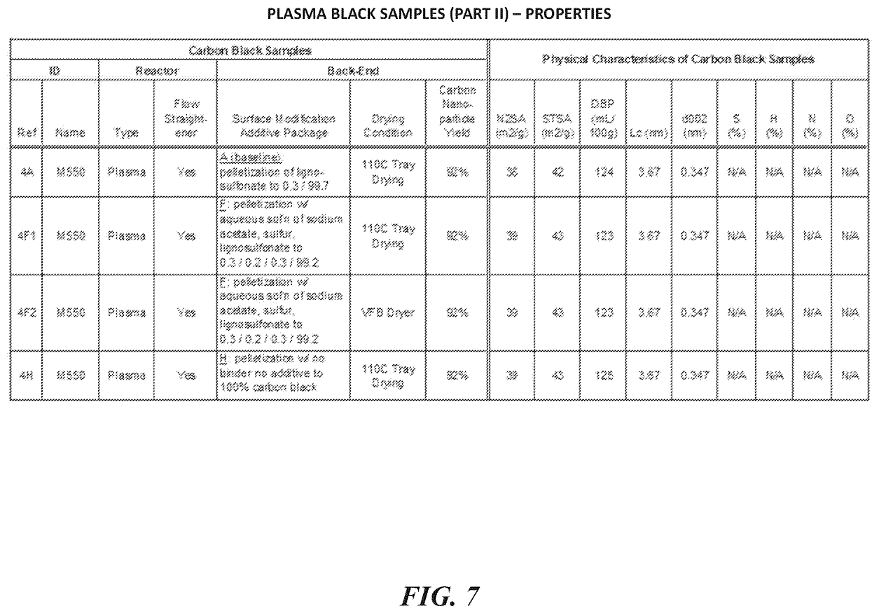

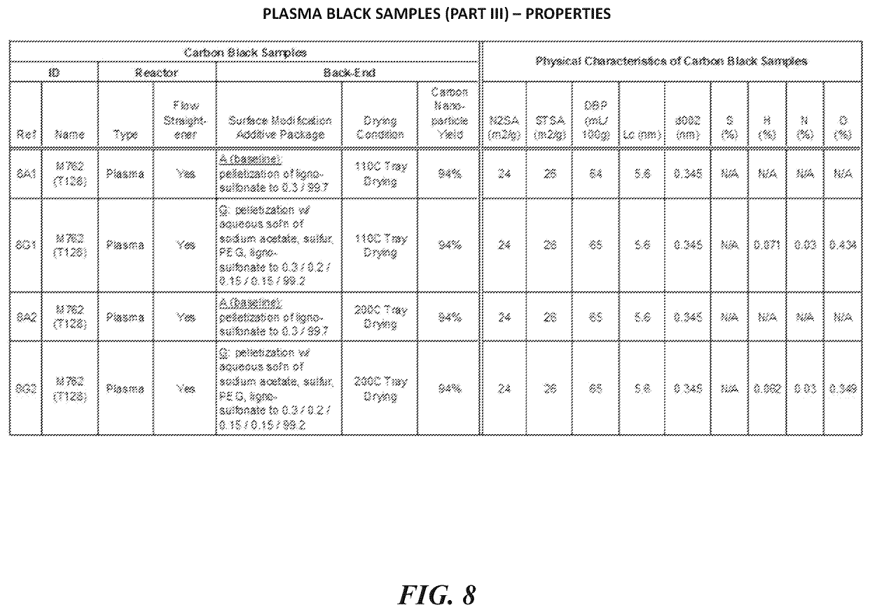

FIG. 6, entitled “Plasma Black Samples (Part I)-Properties,” is a table showing various measured physical properties of Plasma Blacks (reference groups 2, 1, and 6) treated with Baseline “A” or other surface modification (“G” for sample 6G-M762), and dried under various conditions, according to one or more embodiments of the present disclosure. FIG. 7, entitled “Plasma Black Samples (Part II)-Properties,” is a table showing various measured physical properties of Plasma Blacks (reference group 4) treated with Baseline “A” or other surface modification (“F” for samples 4F1-M550 and 4F2-M550 and “H” for sample 4H-M550), and dried under various conditions, according to one or more embodiments of the present disclosure. FIG. 8 is a table showing various measured physical properties of Plasma Blacks (reference group 8) treated with Baseline “A” or other surface modification (“G” for samples 8G1-M762 and 8G2-M762), and dried under various conditions, according to one or more embodiments of the present disclosure.

As shown in FIGS. 6-8, after treatment with a Surface Modification Additive Package, all Plasma Black samples were dried under a Drying Condition. Some Plasma Black samples were tray dried at 110° C.: 2A-M550, 1A-M762, 6A-M762, 6G-M762, 4A-M550, 4F1-M550, 4H-M550, 8A1-M762(T128), 8G1-M762(T128). Some Plasma Black samples were tray dried at 200° C.: 2A-M550@200C, 8A2-M762(T128), and 8G2-M762(T128). One Plasma Black sample was dried via vibratory fluidized bed (VFB) dryer: 4F2-M550.

After drying, physical characteristics of the Plasma Black carbon pellets were then measured. The physical characteristics measured are nitrogen surface area (N2SA) and statistical thickness surface area (STSA), as measured by ASTM D6556-10, the dibutyl phthalate (DBP) absorption as measured by ASTM D2412-12, the crystallinity of the carbon particle (L_{c}) and analysis of the 002 peak of graphite (d₀₀₂) as measured by x-ray diffractometry (e.g., using copper K_{α} at a voltage of 40 kilovolts, a current of 44 milliamps, a scan rate of 1.3 degrees per minute from 2Θ of 12 to 90 degrees) as analyzed by the Scherrer equation (with larger Le values corresponding with greater crystallinity and smaller d₀₀₂ values corresponding to higher crystallinity and more graphitic structure, with d₀₀₂ values of greater than about 0.355 being indicative of turbostratic carbon), and elemental analysis of sulfur (S), hydrogen (H), nitrogen (N), and oxygen (O) determined by atomic absorption spectroscopy. Resulting data are as shown.

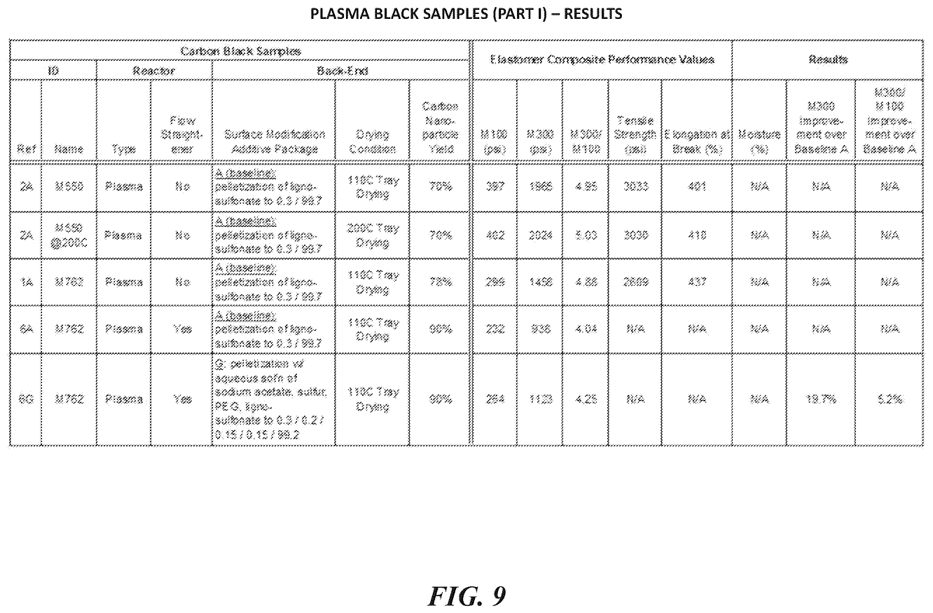

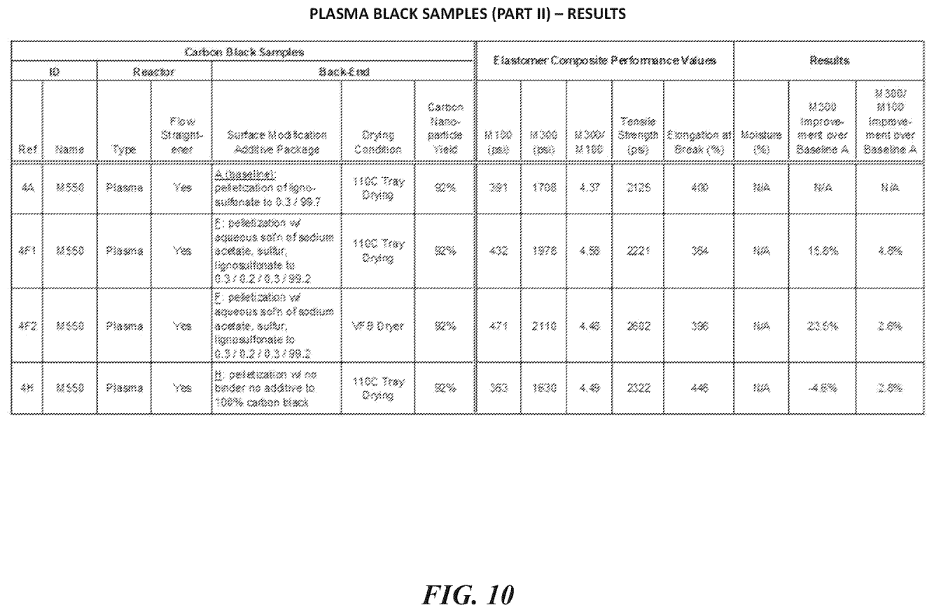

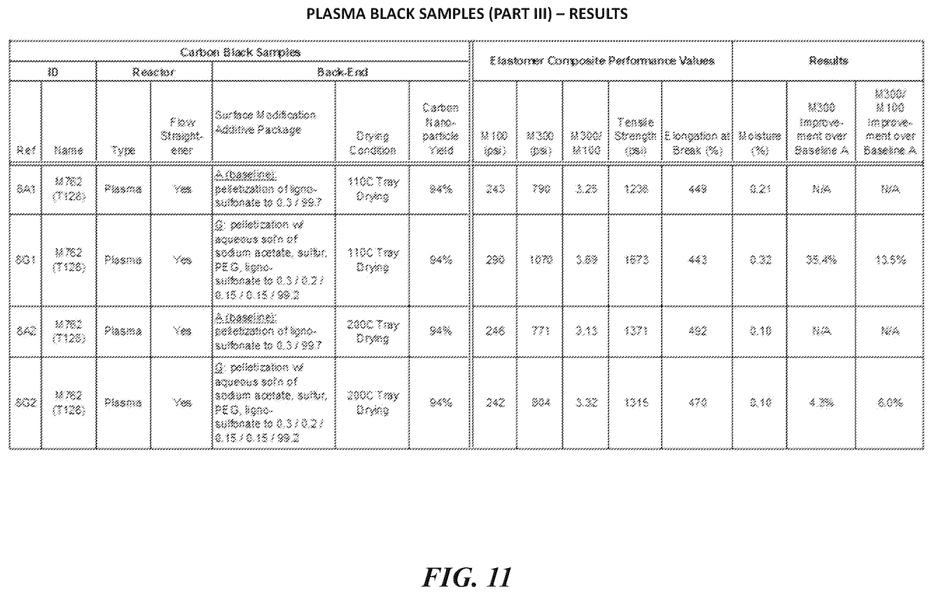

FIGS. 9, 10, and 11 are tables showing various measured performance properties of elastomer composites made using the Plasma Black samples of Monolith® carbon black grades M550 and M762 of FIGS. 6, 7, and 8, respectively, according to one or more embodiments of the present disclosure. More specifically, FIG. 9 is a table showing various measured performance properties of elastomer composites made using the Plasma Blacks of FIG. 6, FIG. 10 is a table showing various measured performance properties of elastomer composites made using the Plasma Blacks of FIG. 7, and FIG. 11 is a table showing various measured performance properties of elastomer composites made using the Plasma Blacks of FIG. 8, each according to one or more embodiments of the present disclosure.

The elastomer composites were prepared using the identified Plasma Blacks and styrene butadiene rubber specimens prepared according to ASTM D3191. For each sample, the elastomer composite was generated in a same way, and in the same way the elastomer composites were generated for the furnace black samples described above, allowing for comparison of the values. The elastomer composite performance values measured are elastic modulus M100 (modulus at 100% elongation of an elastomer sample reinforced with the corresponding furnace black carbon particles), elastic modulus M300 (modulus at 300% elongation of an elastomer sample reinforced with the corresponding furnace black carbon particles), tensile strength, and elongation at break as measured by ASTM D412, as well as moisture content as determined by ASTM D1509. The performance property M300/M100 was determined by dividing the M300 value by the M100 value for the sample.

As shown in FIGS. 9-11, results for Plasma Black samples include evaluation of performance improvements for certain Surface Modification Additive Packages over the Baseline treatment. For samples treated with a Surface Modification Additive Package that is not the Baseline “A” (e.g., Surface Modification Additive Package “F, “G,” or “H”), improvements were calculated for elastomer composite performance values M300 and M300/M100 over the corresponding Baseline “A” sample.

Based on comparison of N2SA and DBP values, which are used to determine carbon black grades, the furnace black samples of FIGS. 4-5 are reference carbon blacks for the purpose of this Example, i.e., carbon black materials made in the furnace process that have values of N2SA and DBP within about 20% of the Plasma Black carbon particles produced by the methods and/or additives of the present disclosure.

For the Plasma Black samples of FIGS. 6-11, although crystallinity Lc is more than double on average compared to the furnace black counterpart, the hydrogen content (H) is about one-third of the furnace black counterpart, and there is more than 10× less sulfur (S) present, the Plasma Black samples reinforce the rubber of the elastomer composites well.

The importance of Drying Condition can be seen in FIG. 11 for the 8A and 8G samples listed. While furnace black can be dried at 110° C. or 200° C. for 12 hours with no substantial impact on performance (see FIG. 5), for the Plasma Blacks treated with Surface Modification Additive Package “G”, the performance difference over Baseline “A” is apparent. For example, for the Surface Modification Additive Package “G” sample dried at 110° C. (8G1-M762(T128)), the improvements in M300 and M300/M100 over the Baseline treatment are 35.4% and 13.5%, respectively. For the Surface Modification Additive Package “G” sample dried at the higher temperature of 200° C. (8G2-M762(T128)), the improvements in M300 and M300/M100 over the Baseline treatment are 4.3% and 6.0%, respectively. Yet, regardless of Surface Modification Additive Package, the Group 8 carbon particles themselves are almost indistinguishable by nearly all physical characteristics, including (see FIG. 8) N2SA, DBP, Lc, and d002. The only physical characteristics that differ slightly among the 8G and Baseline 8A samples are oxygen percentage (O) and moisture content, yet these slight differences can result in elastomer composite performance improvement by an unexpected 30+% (see FIG. 11). At minimum, this Example shows that the “wet” sample at 0.3% moisture content (8G1-M762(T128)) demonstrated >30% performance improvement, and the “dry” sample at 0.1% moisture content (8G2-M762(T128)), while showing some improvement, performed nearly the same as the corresponding Baseline sample, The aforementioned Group 8 data from this Example thus show that a carbon particle having a surface modification (e.g., Surface Modification Additive Package “G”) according to embodiments of the present disclosure, when heated at about 200° C. for about 12 hours, may have an elastomer reinforcement performance value that returns to a level substantially the same as an untreated carbon particle (e.g., Baseline “A”). Further, the carbon particle having the surface modification (e.g., Surface Modification Additive Package “G”), when heated to a temperature of at most about 110° C., may have an improved modulus M300 of at least about 10% as compared to an untreated carbon particle (e.g., Baseline “A”) or as compared to the carbon particle having the surface modification and heated at about 200° C. for about 12 hours.

In this Example, the presence of a hydrated salt in the form of sodium acetate trihydrate at 0.3% by mass on an anhydrous basis can be seen to correlate with significant improvements in the M300 and M300/M100 ratio, which can correlate with improved reinforcement properties. The moisture in the hydrated salt can provide moisture local to the carbon particles which can, in turn, be used in the reinforcement reaction to bind the surface of the carbon particles to the elastomer composite. For example, the moisture released from the hydrated salt can react with zinc oxide in the reinforcement package. The moisture may decrease the wetting properties of the elastomer to the carbon particles. This provides a surprising result, as the reinforcement performance of the carbon particles can be increased without a significant impact on the dispersion of the particles despite the decreased wetting properties of the elastomer.

### Computer Systems

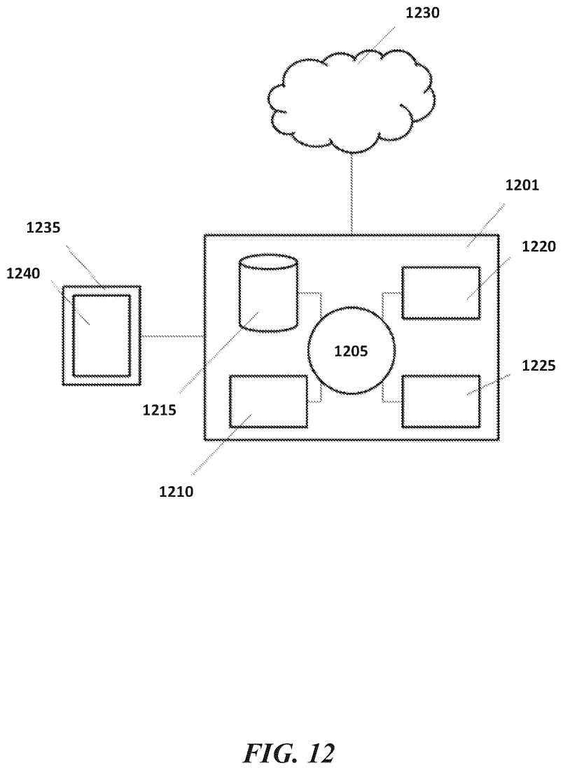

The present disclosure provides computer systems that are programmed to implement methods of the disclosure. FIG. 12 shows an example computer system 1201 that is programmed or otherwise configured to operate the systems or execute the methods of the present disclosure. The computer system 1201 can regulate various aspects of the present disclosure, such as, for example, reactor conditions for the generation of carbon particles decorated with one or more hydrates, hydrated salts, carboxylate salts, carboxylates, or carboxylic acids. The computer system 1201 can be an electronic device of a user or a computer system that is remotely located with respect to the electronic device. The electronic device can be a mobile electronic device.

The computer system 1201 includes a central processing unit (CPU, also “processor” and “computer processor” herein) 1205, which can be a single core or multi core processor, or a plurality of processors for parallel processing. The computer system 1201 also may include memory or a memory location 1210 (e.g., random-access memory, read-only memory, flash memory), an electronic storage unit 1215 (e.g., hard disk), a communication interface 1220 (e.g., network adapter) for communicating with one or more other systems, and peripheral devices 1225, such as cache, other memory, data storage and/or electronic display adapters. The memory 1210, storage unit 1215, interface 1220 and peripheral devices 1225 are in communication with the CPU 1205 through a communication bus (solid lines), such as a motherboard. The storage unit 1215 can be a data storage unit (or data repository) for storing data. The computer system 1201 can be operatively coupled to a computer network (“network”) 230 with the aid of the communication interface 1220. The network 1230 can be the Internet, an internet and/or extranet, or an intranet and/or extranet that is in communication with the Internet. The network 1230 in some cases is a telecommunication and/or data network. The network 1230 may include one or more computer servers, which can enable distributed computing, such as cloud computing. The network 1230, in some cases with the aid of the computer system 1201, can implement a peer-to-peer network, which may enable devices coupled to the computer system 201 to behave as a client or a server.

The CPU 1205 can execute a sequence of machine-readable instructions, which can be embodied in a program or software. The instructions may be stored in a memory location, such as the memory 1210. The instructions can be directed to the CPU 1205, which can subsequently program or otherwise configure the CPU 1205 to implement methods of the present disclosure. Examples of operations performed by the CPU 1205 can include fetch, decode, execute, and writeback.

The CPU 1205 can be part of a circuit, such as an integrated circuit. One or more other components of the system 1201 can be included in the circuit. In some cases, the circuit is an application specific integrated circuit (ASIC).

The storage unit 1215 can store files, such as drivers, libraries and saved programs.

The storage unit 1215 can store user data, e.g., user preferences and user programs. The computer system 1201 in some cases may include one or more additional data storage units that are external to the computer system 1201, such as located on a remote server that is in communication with the computer system 1201 through an intranet or the Internet.

The computer system 1201 can communicate with one or more remote computer systems through the network 1230. For instance, the computer system 1201 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1201 via the network 1230.

Methods as described herein may be implemented by way of machine (e.g., computer processor) executable code stored on an electronic storage location of the computer system 1201, such as, for example, on the memory 1210 or electronic storage unit 1215. The machine executable or machine-readable code can be provided in the form of software.

During use, the code can be executed by the processor 1205. In some cases, the code can be retrieved from the storage unit 1215 and stored on the memory 1210 for ready access by the processor 1205. In some situations, the electronic storage unit 1215 may be precluded, and machine-executable instructions may be stored on memory 1210.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 1201, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various wireless or air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement databases, etc. Volatile storage media may include dynamic memory, such as main memory of such a computer platform. Tangible transmission media may include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1201 can include or be in communication with an electronic display 1235 that comprises a user interface (UI) 1240 for providing, for example, operating a reactor. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 1205. The algorithm can, for example, execute operations to perform any of the operations in FIG. 1 in whole or in part.

While various embodiments of the present disclosure have been shown and described herein, those skilled in the art will understand that such embodiments are provided by way of example only. It is not intended that the present disclosure be limited by the specific embodiments, examples, or descriptions and illustrations of the embodiments provided within the specification. Numerous variations, changes, and substitutions may occur to those skilled in the art without departing from the present disclosure. It should be understood that all aspects of the present disclosure are not limited to the specific depictions, configurations or relative proportions set forth herein which depend upon a variety of conditions and variables. It should be understood that various alternatives to the embodiments described herein may be employed in practicing the methods and additives of the present disclosure, without departing from the disclosure. It is therefore contemplated that the present disclosure shall also cover any such alternatives, modifications, variations, or equivalents. It is intended that the following claims define the scope of the invention and that methods and additives within the scope of these claims and their equivalents be covered thereby.

1. A method, comprising:
(a) providing a carbon particle; and
(b) adding, to the carbon particle, an additive mixture comprising one or more of a hydrate, a hydrated salt, a carboxylate salt, a carboxylate, or a carboxylic acid, thereby forming a treated carbon particle.

2. (canceled)

3. The method of claim 1, further comprising, prior to step (a), generating the carbon particle in a plasma process.

4. (canceled)

5. The method of claim 1, further comprising:
(c) pelletizing the treated carbon particle to generate a carbon pellet.

6. The method of claim 5, further comprising:
(d) drying the carbon pellet such that the one or more of the hydrate, the hydrated salt, the carboxylate salt, the carboxylate, or the carboxylic acid decorates the surface of the carbon pellet.

7. The method of claim 6, wherein the drying is to a moisture content in a range of about 0.2% to about 5%.

8. The method of claim 1, wherein the hydrated salt comprises sodium acetate trihydrate or sodium maleate.

9. The method of claim 1, wherein the hydrate comprises one or more of hydrated sodium acetate, zinc formate, ammonium formate, zinc acetate, zinc glycolate, sodium glycolate, sodium tannate, or zinc tannate.

10. The method of claim 9, wherein the hydrate further comprises crosslinked methacrylate hydrate in combination with acid or acid salt.

11. The method of claim 1, wherein the additive mixture comprises one or more of lignosulfonate, sulfur, a sulfur containing compound, a metal organic framework, micelle encapsulated water, a molecular sieve comprising water, a superabsorbent polymer, a filler, an oil, a metal oxide, a peroxide or a reaction product therefrom, or a vulcanization accelerator.

12. The method of claim 1, further comprising, in step (b), adding a pelletizer solution to the carbon particle.

13. The method of claim 12, wherein the additive mixture comprises the pelletizer solution.

14. (canceled)

15. The method of claim 6, further comprising:
(e) using the carbon pellet in an elastomer reinforcement process wherein the carbon pellet and the elastomer are combined to form a composite.

16.-23. (canceled)

24. The method of claim 1, wherein the treated carbon particle comprises at most about 1.5% by mass of the one or more of the hydrate, the hydrated salt, the carboxylate salt, the carboxylate, or the carboxylic acid.

25. (canceled)

26. (canceled)

27. The method of claim 6, wherein the one or more of the hydrate, the hydrated salt, the carboxylate salt, the carboxylate, or the carboxylic acid increases a hydrophilic spreading pressure of the treated carbon particle of the carbon pellet when compared to a reference carbon particle without the one or more of the hydrate, the hydrated salt, the carboxylate salt, the carboxylate, or the carboxylic acid of step (b).

28. The method of claim 1, wherein the one or more of the hydrate, the hydrated salt, the carboxylate salt, the carboxylate, or the carboxylic acid is configured to release water from the treated carbon particle upon an elevation of temperature.

29. The carbon particle of claim 28, wherein the elevation of temperature is performed during an elastomer reinforcement process.

30. (canceled)

31. (canceled)

32. The method of claim 1, wherein the carbon particle has a volume equivalent sphere diameter of at most about 2 micrometers or a surface area of at least about 5 square meters per gram (m2/g).

33. (canceled)

34. (canceled)

35. The method of claim 6, wherein the carbon pellet has a moisture content in a range of about 0.2% to about 5%.

36.-41. (canceled)

42. The method of claim 15, wherein the composite has a modulus at 300% elongation (M300) of at least about 10% more, or a ratio of the modulus at 300% elongation to a modulus at 100% elongation (M300/M100) of at least about 5% more, than a composite comprising the elastomer and a similar but different carbon particle that does not comprise the surface decorated with the one or more of the hydrate, the hydrated salt, the carboxylate salt, the carboxylate, or the carboxylic acid.

43. (canceled)

44. (canceled)

45. (canceled)

46. The method of claim 15 , wherein the elastomer is selected from a group consisting of natural rubber, polybutadiene, polyisobutylene, polyisoprene, nitrile rubber, butyl rubber, halobutyl, ethylene propylene rubber, ethylene propylene diene rubber, silicone rubber, and a fluoroelastomer.

47.-55. (canceled)
